(19) United States
(12) Patent Application Publication
(10) Pub. No.: US 2024/0038205 A1
(43) Pub. Date: Feb. 1, 2024

(54) SYSTEMS, APPARATUSES, AND/OR METHODS FOR REAL-TIME ADAPTIVE MUSIC GENERATION

(71) Applicants: Ryan Alexander GROVES, Berlin (DE); Andrew John ELMSLEY, Berlin (DE); Valerio VELARDO, Berlin (DE)

(72) Inventors: Ryan Alexander GROVES, Berlin (DE); Andrew John ELMSLEY, Berlin (DE); Valerio VELARDO, Berlin (DE)

(21) Appl. No.: 18/359,770

(22) Filed: Jul. 26, 2023

Related U.S. Application Data
(60) Provisional application No. 63/392,437, filed on Jul. 26, 2022.

(51) Int. Cl. G10H 1/00

(52) U.S. Cl. CPC G10H 1/0025; G10H 2240/085; G10H 2220/135; G10H 2220/091

(57) ABSTRACT

Disclosed herein are systems, apparatus, and/or methods for automatically generating in real-time an adaptive digital music stream that satisfies a particular scenario (either static or changing), as described by the dynamic input of an emotional vector (possibly with emotional direction/target), one or more musical styles and one or more musical themes, using an automated music composition, performance and audio production system based which utilizes machine learning and artificial intelligence techniques.

### CROSS-REFERENCE TO RELATED APPLICATIONS

This application claims the benefit of U.S. Patent Application Ser. No. 63/392,437, filed on Jul. 26, 2022, the disclosure of which is incorporated herein by reference in its entirety.

### FIELD OF THE INVENTION

The present disclosure generally relates to systems, apparatuses, and methods for real-time adaptive music generation.

### BACKGROUND

Digital content is exploding, largely driven by an increase in easy-to-use authoring tools and user-generated content (UGC) platforms. Facebook now has over 2 billion monthly active users, with 5 new profiles being created every second. Every year users upload 200M hours of video content on YouTube and over 500 million Snapchat snaps. User demand for creating and sharing deeper interactive experiences is also on the rise. Users are spending over 800 million hours per month creating and sharing interactive experiences on platforms such as Minecraft and Roblox. The Unity game engine has proved that a complex task—game creation—can be streamlined in such a way that it provides value to amateur and professional developers alike. Now, an estimated 770 million people are playing games made with the tool.

These UGC platforms and authoring tools can be seen as “content gatekeepers.” They all provide the tools necessary for their users to easily create and share their digital content; be that a simple status update or a complex gaming experience. The content gatekeeper provides a content creation service to their users, and so their top priority is to provide a simple, seamless experience. This in turn increases the total user engagement and eases the user acquisition process, which are both important revenue drivers.

However, music creation may be a problem facing various content gatekeepers. An absence of a soundtrack or a soundtrack that does not suit a piece of media may adversely affect a viewer's experience. From the beginning of cinema, music has been recognized as essential, contributing to the atmosphere and giving the audience vital emotional cues to increase their immersion. The same is true today for all forms of media and is especially true for interactive experiences such as video games and VR.

When it comes to providing a music solution, content gatekeepers face many issues. Firstly, there is simply not enough original music to meet the demand in digital media. The little music that does exist is often lumbered with complex and expensive copyright and sync clauses. Furthermore, music libraries are difficult to search and break the workflow of the user, who has to go to a third party to find suitable music for their creations.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

Provided herein are systems, apparatuses, articles of manufacture, methods and/or computer program product embodiments, and/or combinations and sub-combinations thereof, for real-time adaptive music generation.

In some embodiments, the systems, apparatuses, articles of manufacture, methods and/or computer program product embodiments, and/or combinations and sub-combinations thereof may provide for the decomposition of music generation into machine-learnable building blocks (or AI modules). In some embodiments, these AI modules may span music composition, performance and audio production aspects of music generation. In some embodiments, the systems, apparatuses, article of manufactures, methods and/or computer program product embodiments, and/or combinations and sub-combinations thereof may further provide for the acquisition and curation of (crowd-sourced) musical data, music generation decisions and preferences to inform the specific machine-learnable building blocks and improve the quality of said AI modules. In some embodiments, the systems, apparatuses, articles of manufacture, methods and/or computer program product embodiments, and/or combinations and sub-combinations thereof may provide for a real-time re-composition of these machine-learnable building blocks into a unique music composition (both in streamed or stored formats) that can interact with and adapt to either user-generated or software-generated stimuli.

In some embodiments, the systems, apparatuses, article of manufactures, methods and/or computer program product embodiments, and/or combinations and sub-combinations thereof may further provide for a framework for mapping the user- or software-generated stimuli in real-time to the desired musical outcome. In some embodiments, the systems, apparatuses, articles of manufacture, methods and/or computer program product embodiments, and/or combinations and sub-combinations thereof may further provide for the precise definition and crafting of a musical scenario, including but not limited to musical styles, musical themes, and emotions or emotional trajectories, style-to-musical parameter mappings, emotion to musical parameter mappings, and instruments.

In some embodiments, the systems, apparatuses, articles of manufacture, methods and/or computer program product embodiments, and/or combinations and sub-combinations thereof may further provide for a framework for aggregating the emotional content of input stimuli and discovering the over-arching emotional state and a framework for modifying the musical scenario to elicit the desired emotional state by moving in real-time through an emotional space.

In some embodiments, the systems, apparatuses, articles of manufacture, methods and/or computer program product embodiments, and/or combinations and sub-combinations thereof may further provide a user-directed AI generation of musical scenarios by iteratively guiding the AI modules during the generation of musical elements, where each iteration further converges on the immediate musical preferences and goals of the user for that particular musical element. This process may ultimately generate a musical scenario that may be realized by the music generation system to create an interactive music composition that has been explicitly guided by user preference. In some embodiments, individual music compositional preferences may be determined and can be applied to future composition on a per-user preference basis.

In some embodiments, the systems, apparatuses, articles of manufacture, methods and/or computer program product embodiments, and/or combinations and sub-combinations thereof may allow for the explicit modification of musical parameters in real-time and to continuously vary the musical material of a piece in order to create a stream of infinite, non-repeating, yet congruent music. In some embodiments, the systems, apparatuses, articles of manufacture, methods and/or computer program product embodiments, and/or combinations and sub-combinations thereof may further provide a smooth transition the musical material from one musical piece to another and allow the user to use the same musical theme in multiple scenarios in order to create a consistent real-time musical soundtrack.

In some embodiments, the systems, apparatuses, articles of manufacture, methods and/or computer program product embodiments, and/or combinations and sub-combinations thereof may provide an interface for the crafting of musical scenarios for the purpose of music generation and provide for real-time generation of long-term musical structure and form.

In some embodiments, the systems, apparatuses, articles of manufacture, methods and/or computer program product embodiments, and/or combinations and sub-combinations thereof may further provide for a complete embedded music generation system suitable for multiple host environments including but not limited to game engines, applications, and cloud platforms, generating music in both real-time and non-real-time and for the aggregation and elicitation of emotions in multi-agent environments.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE FIGURES

Example embodiments will be described and explained with additional specificity and detail through the accompanying drawings in which:

FIG. 1 is a diagram of an example embodiment of a Real-Time Adaptive Music Generation System (RTAMGS) according to one or more embodiments of the present disclosure.

FIG. 2 illustrates a flowchart of an example hierarchical structure of generated music according to one or more embodiments of the present disclosure.

FIG. 3 illustrates an example music unit and storage data associated with the music unit according to one or more embodiments of the present disclosure.

FIG. 4 illustrates an example generation process of a music unit (MMU) according to one or more embodiments of the present disclosure.

FIG. 5 illustrates an example process of generating a music unit on a MU-by-MU basis according to one or more embodiments of the present disclosure.

FIG. 6 illustrates an example of a metric level dot notation for representing musical rhythms according to one or more embodiments of the present disclosure.

FIG. 7 illustrates an example song with labeled metric levels according to one or more embodiments of the present disclosure.

FIG. 8 illustrates a Digital Signal Processing graph that may be implemented as part of a synthesis component of the RTAMGS according to one or more embodiments of the present disclosure.

FIG. 9 illustrates an example reduced set of samples for generating music notes corresponding to a particular octave according to one or more embodiments of the present disclosure.

FIG. 10 illustrates a training process of a MIDI-to-Audio Synthesis (MTAS) model according to one or more embodiments of the present disclosure.

FIG. 11 illustrates an example process of preparing training data for the MTAS model according to one or more embodiments of the present disclosure.

FIG. 12 illustrates an additional or alternative training process of the MTAS model according to one or more embodiments of the present disclosure.

FIG. 13 illustrates an example process of generating a musical theme using a real-time repetition structure according to one or more embodiments of the present disclosure.

FIG. 14 illustrates an example process of generating a musical theme using a real-time variation structure according to one or more embodiments of the present disclosure.

FIG. 15 illustrates example emotion points in a valence-arousal space according to one or more embodiments of the present disclosure.

FIG. 16 illustrates an example emotion change of the emotion points in the valence-arousal space according to one or more embodiments of the present disclosure.

FIG. 17 illustrates an example cloud streaming service configured to perform a music generation process according to one or more embodiments of the present disclosure.

FIG. 18 is a flowchart of an example method of music generation according to one or more embodiments of the present disclosure.

FIG. 19 is an example computing system according to one or more embodiments of the present disclosure.

### DETAILED DESCRIPTION OF THE INVENTION

These problems are compounded when the user would like the music that adapts to the emotional journey of their content, as expected by media viewers. For example, video games have been using an approximation of adaptive music since their early days to dynamically change the music depending on user interaction and the emotional setting of a scene. For example, if in a video game the main character explores a cheerful village, the music can be calm and happy. When the character gets attacked by a group of enemies, the music gets more tense to support the action unfolding through audio feedback.

For the music to be truly adaptive, it should smoothly morph from one emotional state to another and/or from one style to another. Recently, a new solution for creating such music has presented itself: Artificial Intelligence (AI). Tell the AI composer the style of music, and the desired emotion, and the music is created in seconds. This has an empowering effect on users. For the first time anyone, no matter their level of musicianship, can create music.

It is important that any music solution handle emotional changes within a piece of music, providing a dynamic and exciting way for any user to create deep interactive and emotional experiences. Accordingly, providing dynamic musical changes in both interactive and traditional media may facilitate creating various emotional states presented by a particular piece of media.

The primary driver of the digital content market is the wave of content creation happening in every medium. Internet users create a massive amount of original content. The strongest communities online have been built around the ability for people to connect with others, create original content and share, often based around a particular medium. Snapchat lets users create and share image and video content, and users are contributing Snaps at a rate of 500 million per year. Instagram users share photos and stories at an impressive rate of 90 B per day. Video and streaming content is likewise on the rise, with digital video viewership growing by an average of over 10% each year since 2013. In gaming, the market is moving strongly towards providing games as a service rather than a single point of sale. From 2010 to 2015, there has been a shift of around 20% in the market from games as a product to games as a service. For example, Grand Theft Auto V (GTA V) was released in September of 2013, and it still ranks in the top 10 for monthly game sales 4 years later. In fact, GTA V has been in the top 10 charts for 41 of the 49 months it has been available, as of August 2017. This is largely due to the developer's commitment to continuously releasing high-quality content, often with multiplayer options. Online gaming (like massively multiplayer online role-playing games) has a long-standing gargantuan user base. The world was spending 3 billion hours a week in online games since 2011. That's 156 billion hours every year, largely before the trend in gaming as service emerged.

The emersion of VR as a big player in the digital content market has driven new opportunities for users to directly contribute to the growing wave of content. This had led to a rise in metaverse companies in the VR space. Coined by Neal Stevenson, a metaverse is a persistent virtual world that is created with the collaboration of many users. In theory, the metaverse is a single all-encompassing virtual universe that replaces our reality and connects all possible virtual spaces. In practice, companies have been creating their own disjunct metaverses, often with the ability to create not only virtual spaces, but also to encode the logic for games and other interactive experiences through scripting engines and sophisticated editors. A great example of this is Roblox, who have created a platform where anyone can develop their own games with their simple editor and scripting language. To date, over 29 million games have been released that were exclusively developed by 3rd-party developers, and the ecosystem boasts 64 million monthly active users spending 610 million hours per month on the platform. In VR, companies like High Fidelity VR, Linden Lab, Mindshow, VR Chat, and Facebook (with Facebook Spaces) are all creating simple tools to create and share virtual spaces.

User-generated content (UGC) is not limited to interactive media. Linear media like video have active communities constantly sharing and creating content in huge numbers. For example, users of YouTube upload over 200 million hours of content every year, with more than 500 million hours watched every day. The video streaming platform Twitch broadcasts over 6.5 B hours of content each year.

The accumulation of all these different forms of digital media and the communities that contribute to them amount to a massive challenge: that of sourcing music to support this visual content. Take the interactive media space, where users are spending over 150 billion hours a year playing games and interacting in virtual worlds. Consider the time spent only in the experiences that were created by other users on these UGC platforms; that figure is still over 10 billion hours per year.

The UGC music content problem is the most clear-cut. When given the opportunity, these types of interactive experiences often come with a custom musical soundtrack that has been composed for that particular piece of content. With UGC, that is simply not possible. The user would have to source their own music and somehow integrate it into the experience, and that would only work for adding existing music to the experience. The real challenge is creating custom music for that amount of content. In the traditional model, game developers commission independent composers to compose custom music. A typical composer can easily spend 12 hours of work time in order to compose 7 minutes of music and would charge at least $2100 for a small project. That amounts to roughly 100 hours of labor for each hour of music, at a cost of $18,000 per hour of music.

Music in interactive content should reflect the non-linearity of the media, by dynamically adapting to users' interactions. For this reason, it is important to create a dynamic musical experience for each user, so that the music can be tailored to the trajectory of the user in an interactive experience. In order for human composers to compose custom music for every hour spent in interactive media, it would require 150 billion hours of music content, which equates to 15 trillion hours of labor per year. To put that in perspective, that's roughly 7 million people composing music every single hour for 365 days straight. The resulting music library would be roughly 75 thousand times the size of Spotify's library.

Beyond simply being impossible to satisfy demand, there are problems with existing music acquisition methods. First off, interactive content creation platforms largely don't have any integrated music solution, so there is simply no way to add music. With linear media, the process for obtaining custom music has just a few options, such as scouring through royalty-free music libraries to find something that exactly fits the emotional setting of the content, which is likely not unique to the content and may be found and used in the creation of other media content. Additionally or alternatively, hiring a composer to create custom music or using music creation software (like GarageBand) to compose original musical creations may be used to generate custom music.

If a user can be satisfied by using music that already exists, they have to deal with copyright issues and complicated music licensing regulations, assuming they can comprehend all the legal aspects. Beyond that, all of these options pull the user out of the existing workflow of creating (or even submitting) the content.

Creating music has traditionally been a highly specialized task, performed by people with significant musical knowledge and experience. Composers, songwriters and electronic music producers are at the core of the music creation process. Composers study for years in order to master how to write for orchestra and for different ensembles. Songwriters usually have a long experience with one or more instruments, often piano and/or guitar. They craft their songs constantly going back and forth from the refinement of the lyrics to the composition of the music accompaniment and of the vocal line. Electronic producers train for years with Digital Audio Workstations (DAWs) like Cubase or Logic, to create their captivating sounds and to reach the level of production quality that is required in electronic music today.

As of today, music creation is performed mainly by musically skilled people. In this regard, things have not changed much from the time of Mozart and Beethoven. Of course, technology has advanced a lot throughout this period. Now, music creators have access to tools that help them speed up their compositional workflow. For example, DAWs and sample libraries make it possible to mock-up the sound of an 80-instrument orchestra and 100-element choir with incredible realism. Music software like Sibelius speeds up the score notation process, which was previously carried out manually. However, technology has historically only had an impact on the productivity of music creators. Who is actually making the music has not changed.

What are the implications for content gatekeepers? As we have seen in the previous section, there is a massive demand for original musical content on digital platforms, but the demand can be satisfied, partially, only by human-composed music. Depending on the musical requirement of the type of content gatekeeper involved, the user has a number of options to acquire music.

For complex digital projects like games and VR/AR experiences, users can hire a composer or a music producer to get the soundtrack they want. This is expensive and time consuming. It also does not make sense for other types of digital content, like short videos or micro content, where the music requirements are less demanding. In these cases, there are other music alternatives, which ultimately rely on manual music creation. These include music libraries, licensed music, or, if the user has enough time and musical skills, they can simply produce the music themselves.

Music libraries are services that offer a variety of music selections. They can often be searched through style, emotion and other relevant tags. Music libraries come in all shapes and forms. Some have royalty-free licenses whereas others are completely free to use. With royalty-free music, users can access an online library, like PremiumBeat, search for the music they want, and then buy the piece for a fixed price. Users can then import the pieces they have bought in their content and publish it. There are also music libraries that allow users to use their music completely for free. However, in this case the quality of the music is often poor.

Sometimes music libraries can be directly integrated into the content gatekeeper's platform. For example, YouTube has AudioLibrary, a service that can be used to add tracks to a video for free. Vimeo had a paid music library where users can search and buy tracks.

There are a few issues with music libraries in terms of user workflow disruption, time, lack of customization of the music, and uniqueness. In order to get music from a music library, users often have to abandon the platform, go to a specialized online music library, and spend a lot of time searching for the right music. This disrupts the users' workflow and drives them away from the platform. Searching for the right track in a music library is a highly time-consuming effort. Users have to insert tags and search through thousands of options. However, for as much as they can search, users may not find a piece that adapts to their content. Also, the music they can acquire from a music library may not be unique to the user's content as the music can be used in other projects.

Another music solution traditionally adopted by bigger productions is to license the music, paying a license fee based on usage. This solution is feasible only for people who have the money to buy the expensive licenses and is definitely not an effective solution for the vast majority of the digital platform's users. As in the case of music libraries, the music is not customized and may not be uniquely used for a content. Furthermore, the process of licensing the music itself is often complicated and expensive.

With the advent of music software like DAWs, samplers (e.g., Kontakt), software synthesizers (e.g., Massive) and sample libraries (e.g., EastWest Symphonic Orchestra) from the 1990s onwards, music has become much easier to produce. What could only be accomplished with expensive gear and a music studio, can now be accomplished with a mid-tier computer and some music software. This has pushed some of the content creation platforms' users who have a basic knowledge of music production to take a DIY approach. With the help of pre-made loops and samples, users can create their own music relatively easily. However, making music is still extremely time consuming, which is especially true for non-professional musicians. Also, the quality of DIY music is often very low.

Although there are several solutions to acquire music, it is worth mentioning that many content gatekeepers currently ignore the music creation or acquisition problem. In other words, they either provide a minimal music solution or, most often, they provide no solution. This is understandable because, historically, there has been no other music creation solution apart from manual composition. Therefore, it makes sense to leave the burden of finding the music for their content to the user.

AI opens up a whole new opportunity for music creation that was unthinkable only a few years ago. For one, AI solves the music content creation bottleneck problem. While humans cannot create large amounts of music, machines can. If we consider that every year there are close to 200M hours of video uploaded to YouTube, we can easily calculate that it is practically impossible for human music creators to create enough original content to satisfy just the music demand for YouTube videos. AI music generation systems, by contrast, can create enormous amounts of music in short periods of time. AI is the ideal solution to provide customized music to the flood of digital content that is created every day on the Internet and other authoring tools.

However, there are a few points content gatekeepers should look for in an AI music creation solution. First, the solution should seamlessly integrate with the digital platform or authoring tool. In other words, the AI system should act as a music layer that sits on top of the content layer and provides it music. Second, the AI music creation solution should be flexible enough so that users can create custom music that fits their content on a very granular level. For this to happen, the AI music system should provide a simple emotional interface that allows the user to change the emotional state of the music in an intuitive way, at any time in a piece. Finally, in the case of a non-linear content like a game or a VR/AR experience, the AI music solution should create the music in real-time, so that the music can adapt on the fly to whatever is happening in the experience. If a player is attacked, the music should ramp up the intensity. If the protagonist wins a battle, the music should be transformed to celebrate the win; all in real-time. We call this in-experience real-time generation deep adaptive music.

Embodiments of the present disclosure are explained with reference to the accompanying figures.

A Real-Time Adaptive Music Generation System (RTAMGS) may be configured to compose music automatically for a particular scenario and may easily adapt to changing scenarios. The RTAMGS may be implemented as an embeddable software development kit (SDK), so that some or all of the input controls can be accessed via one or more application programming interfaces (APIs) and can be manipulated or modified in real-time. It is to be appreciated that by having an embeddable system, the input system may be easily extended to be implemented via a graphical user interface and/or cloud-based system. Similarly, while the output is a real-time audio buffer, it may also be encapsulated in a static file for the purposes of linear media.

In an example implementation, the level of control provided may be based at least partially on the object-oriented structure, which may also be tailored to its solution. In some embodiments, the RTAMGS may define a particular scenario as a Cue, which may contain an Emotion, a Style, and a Musical Theme. In some embodiments, the adaptivity of the solution may be a different scope depending on the context of the Cue. In some embodiments and within a particular Cue, the Style and Musical Theme may remain as static variables-they may be unchanged. In some embodiments, a Musical Theme may be an abstract and/or concrete musical concept with a defined melody and harmony, which may be implemented in different Styles and Emotions.

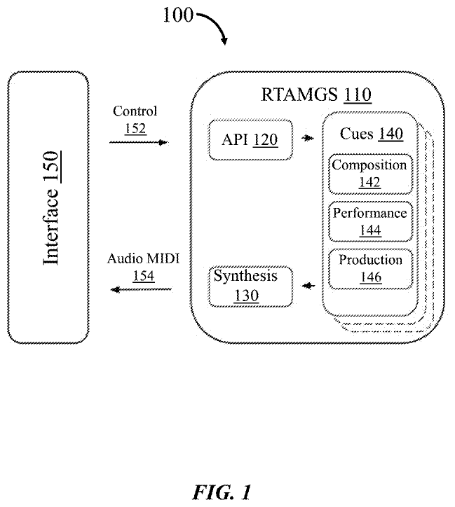

FIG. 1 is a diagram of an example embodiment of a Real-Time Adaptive Music Generation System (RTAMGS) 110 according to one or more embodiments of the present disclosure. In some embodiments, at least a portion of a RTAMGS 110 may be generally configured as an embeddable component and/or system. In an example, the RTAMGS 110 may be implemented as one or more compiled binary containers that may be dynamically loaded and linked at runtime by one or more applications. The one or more compiled binary containers may also be configured to implement one or more APIs 120. It is to be appreciated that the technical name for this is a dynamic library. The one or more applications and the RTAMGS 110 may be further executed by a host system. The one or more applications may include, without limitation, a game engine (e.g., Unity Engine, Unreal Engine, etc.), video editing software (e.g. iMovie, Final Cut Pro, etc.), a digital audio workstation (e.g. Logic Pro, Ableton Live, Reaper etc.), a web server and/or service (e.g. YouTube, Facebook, Instagram etc.), mobile phone applications or any other application that may require generation of music. Additionally or alternatively, the RTAMGS 110 may also be implemented as one or more static libraries that may be compiled with the one or more applications and statically linked. The one or more dynamic and/or static libraries and the one or more applications may then be executed by the host system. The above static and/or dynamic libraries may be sometimes referred to as the RTAMGS SDK.

In an example implementation, the one or more applications executing on the host system may be configured to interface with the one or more components/systems (e.g., implemented as executable code) of the RTAMGS 110 to initialize the RTAMGS 110, and then control the RTAMGS 110 through one or more APIs 120 implemented by the RTAMGS 110. The RTAMGS 110 may then execute one or more active Cues 140 to compose, perform, and produce music, which may then be output as symbolic data (in the form of MIDI messages, in an example) or by synthesized as music synthesis data 130, such as an audio MIDI output 154. In some embodiments, the Cues 140 may include a composition block 142, a performance block 144, a production block 146, or some combination thereof.

In some embodiments, the composition block 142 may involve generating music notes representative of a musical composition based on input information provided to the active Cues 140. The music notes generated with respect to the composition block 142 may be modified based on a particular musical style (e.g., rock, jazz, hip hop, metal, etc.) or a particular emotion (e.g., happy, sad, lonely, etc.) indicated by the input information by the performance block 144. The production block 146 may involve specifying a configuration of virtual instruments or virtual sound generators to output the modified music notes as audio.

It is to be appreciated that the stages of initialization and/or control operations may be substantially similar for any kind of host system (e.g., mobile devices, embedded devices, general purpose computing systems, etc.). All the RTAMGS 100 may need for basic functionality is a call to initialize the RTAMGS 110 and a series of one or more audio buffers to process.

Musical parameters may be hooked up directly as a real-time API, to dynamic programmatic inputs.

The RTAMGS may be generally configured to use Artificial Intelligence (“AI”) or machine-learning techniques, methods, and/or systems to create multiple structural generation or variation and musical generation or variation Models. As discussed herein and elsewhere, the one or more AI modules may also be known as “Models.” These Models may use any AI or machine-learning technique, including but not limited to probabilistic methods, Neural Networks, tree-based methods, or Hidden Markov Models.

Models may refer to machine-learning models that may have been trained on real musical data. The RTAMGS 110 may use the term “Generator” for any Model that has a defined set of specific parameters and may be used to create one or more of the abstract musical objects or create or modify any symbolic data involved in the generation process.

In some embodiments, the Composition Component/System may take as input all of the configuration settings including, but not limited to, all of the User Scenario information (defined below) such as Style, Emotion or emotional trajectories, parameter mappings, etc., as well as musical information and configurations that may in part be defined by the User Scenario or also generated, including but not limited to Parts, Roles, Ensembles, Generators, Models, etc. This information is used for the generation of the output format. In some embodiments and for each Cue 140, an instance of the Composition Component/System will be created and stored in the Cue object, as depicted in the RTAMGS 110 of FIG. 1. The same is true for the Performance Component/System and the Production Component/System.

The RTAMGS 110 may be configured to output the audio MIDI 154 to an interface 150 through which a user may receive the audio MIDI 154. In some embodiments, user input may be received via the interface 150, such as control information 152.

In some embodiments, the Composition Component/System may generate a representation of music that provides all of the information necessary to re-create a musical score. In an example, this may include the sequences of notes (each of which may include but is not limited to pitch, onset, duration, accents, bar, dynamics, etc.) for each Part, the Instruments that are to perform each Part, the dependencies between Parts, and the abstract musical information. As discussed above and herein, the previously mentioned information may be termed as “symbolic music data” or simply described as “symbolic data”.

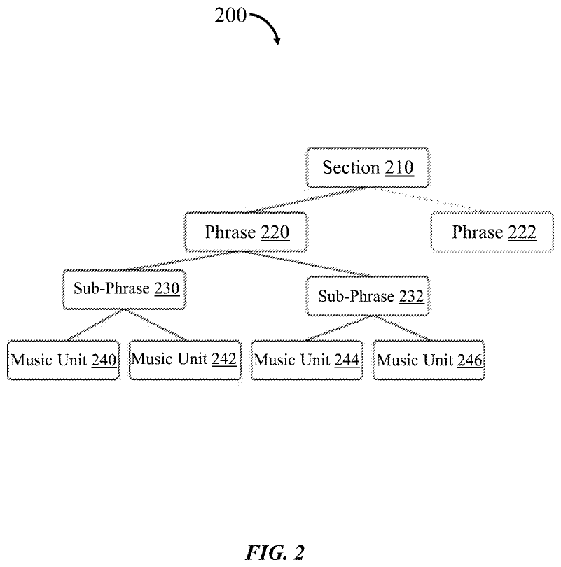

FIG. 2 illustrates a flowchart of an example hierarchical structure 200 of generated music according to one or more embodiments of the present disclosure. In some embodiments, the Real-Time Adaptive Music Generation System (“RTAMGS”) generates music into a hierarchical structure, which may contain, without limitation, Sections 210, Phrases 220 and 222, Sub-phrases 230 and 232, and/or Music Units (MUs) 240, 242, 244, and 246 as structural elements.

In some embodiments, each structural element may be assigned with a name or designation (e.g. the first phrase may be designated as p1, the second sub-phrase may be designated as sp2, and the third MU may be designated as m3). Within the structure, there may be different definitions of referential material. Specifically, the RTAMGS may define repetitions and variations as forms of referential music material.

In some embodiments, a repetition may be an exact copy of a particular element. The repetitions are renamed, so a repetition of an element, such as, first Music Unit m1 becomes first Music Unit, first repetition m1r1; a repetition of the first Music Unit, first repetition m1r1 becomes first Music Unit, second repetition m1r2, and so forth.

In some embodiments, a variation of an element may be a re-statement of the element, with at least one aspect about the element changed. In some embodiments, when a variation occurs, at least one Variation Model from one or more machine-learning models of the RTAMGS may be applied. The types of Variation Models that may be created by the RTAMGS may include, without limitation, structural variations and/or musical variations.

In some embodiments, the structural variations may change an aspect with respect to the structure, by for example, modifying, adding and/or deleting one or more elements. In some embodiments, the Musical variations may act on the musical content, which may include, without limitation, rhythm, melody and/or harmony variations. The variations are also renamed, so that when a first sub-phrase sp1 is varied, a first sub-phrase, first variation sp1v1 is produced.

In some embodiments, the RTAMGS may be configured to generate music with reduced redundancy and duplicity. In an example, the RTAMGS may be configured to avoid creating a copy of a feature (e.g., an element) that does not need to be changed, or newly generated. Because of this, the digital representation of the generated music may be extremely compact. With variations, the RTAMGS may be configured to generate new music from existing music. Similarly, the RTAMGS may be configured to create music with infinite variations, which may create coherent music, and give the listener a sense of familiarity and prevent listener fatigue. The feature of structural linking through references may allow for the creation of a compact digital music representation that explicitly annotates all self-referential material, even for music that is not exactly repeating.

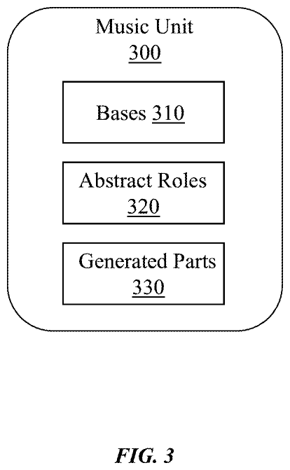

FIG. 3 illustrates an example music unit 300 and storage data associated with the music unit according to one or more embodiments of the present disclosure. In some embodiments, the RTAMGS may be configured to generate music in abstract terms. To generate music in abstract terms, RTAMGS may define musical components including but not limited to Bases 310, abstract Roles 320, generated Parts 330, Ensembles, and their inter-relationships and/or associations as further discussed herein. For each musical component, the system may be configured to create one or more musical objects or representations that pertain to the specific component and may be stored on the component for access and sharing between components. For Role components, these may include abstract representations, like the Basis 310 and the Abstract Role 320. For Part components, in some embodiments, these may include the symbolic data such as note sequences as Generated Parts 330. For ensembles, this information may include Active Parts. All or some of these components may be defined or configured on a per-Music Unit level. An example of some of the data that is stored on the Music Unit 300 is shown in FIG. 3. These data containers such as the Bases 310, the Abstract Roles 320 and the Generated Parts 330 may be empty when the Music Unit 300 if first created, and then populated in the correct order depending on inter-Role dependencies and Part-to-Role dependencies.

In some embodiments and as a general rule, one or more different types of abstract objects may be created during the creation of a Role: the Basis 310 may define a high level of abstraction of musical material, and the Abstract Role 320 may represent an intermediate level of abstraction, in between the Basis 310 and the symbolic data of a generated piece. In a non-limiting case of a melody, for example, the melody Basis object may define the shape of the melody, the relationship to the harmony (i.e., the notes that are part of the underlying harmony, and the transitions between chord tones). Abstract Roles 320 may represent a fuller melody, with embellishments of the Basis 310, such that a full monophonic sequence of notes (in symbolic format) may be later realized. For example, the Abstract Role 320 for the melody may include a set number of notes, a specific rhythm, as well as all or some of the scale degree intervals, which may be generated using the Basis 310 and all of its melodic constraints. The Abstract Role 320 may be populated with enough information for the symbolic data to be created, modified and/or transformed at a later time by the RTAMGS, but may not actually contain absolute notes (as represented as symbolic data) themselves. With respect to the melody Role, this not only means that the same melody may be played across many keys, but also transposition of generated music is only a matter of changing one data point, such as, for example, the starting note. Examples of the types of Roles that the RTAMGS may support includes, without limitation, harmony Roles, melody Roles, and/or percussion Roles. Each of these Roles may have a number of abstract musical objects, including but not limited to a Basis 310 and an Abstract Role 320.

In some embodiments, each abstract object may be an associated with a Generator, i.e., an Abstract Role Generator, or a Basis Generator, which may be referred herein as Role Generators as further discussed herein. In an example, the RTAMGS may include a Role Generator that generates the abstract musical information for bassoon melodies in happy neo-romantic music. Furthermore, the concept of Abstract Roles 320 and Bases 310 may further allow or enable abstract musical material to be shared across multiple generated Parts 330, at multiple levels of abstraction.

Defining these abstract representations and storing them on the composition structure (on the Music Units 300) may allow for the dependencies to be configured in any combination, for any types of Parts and Roles. Additionally, it may further allow for the sharing of information to multiple different sections of a piece, and the variation of previously encountered musical material based on the same abstract representation. For example, a new Music Unit could reference a previously generated Music Unit, such as the Music Unit 300, and generate a new melody based on a modification of the previous Generated Part 330 for the melody. Another embodiment may be for the new Music Unit to generate a new Abstract Role 320 for the melody, based on the previous Music Unit's 300 melody Basis, and then generate a new Generated Part 330 using the newly generated Abstract melody Role as an input.

As mentioned before, a melody Role may depend at least partially on the harmony Role. In some embodiments and based on dependencies, the RTAMGS may be configured to generate some or even all harmony Parts before melody Parts. In instances when only melody Parts are being generated by the RTAMGS, the abstract harmony Parts may still be generated. In many instances, the abstract harmony objects like the Abstract Role 320 and the Basis 310 for the harmony may need to be generated, before generating the melody Part.

Parts may also depend on Role, and on the abstract musical objects that are created for them, such as Abstract Roles 320 and Bases 310. In some embodiments, if a Part is assigned a particular Role, and the Abstract Role 320 for that Role is re-generated, then the RTAMGS may specify that the Generated Part 330 for that Part also be re-generated, as the current Generated Part 330 was generated using the previous Abstract Role 320. These dependencies may ensure the current musical objects reflect the most recent changes in any musical object, because the dependent musical objects may automatically be re-generated.

The RTAMGS may generate music that may be split into several Parts. By way of an example, to generate music for an example rock band, the one or more Parts may include, without limitation: a Drums Part, a Bass Part, a Arpeggio Part, and/or a Lead Part.

In the RTAMGS, a list of Parts may be referred to as an Ensemble. As discussed, there may be a substantial number of commonalities between some of these Parts in terms of the semantic role that they play in the generated music. As such, the RTAMGS may be configured to assign Roles to Parts. With continued reference to the above example, the example rock band may further include the above Parts with their associated Roles: a Drums Part associated with percussion Role, a Bass Part associated with melody Role, also dependent on harmony Role, a Arpeggio Part associated with harmony Role, and/or a Lead Part associated with melody Role, also dependent on harmony Role.

Based on the above associations, the RTAMGS may be configured to model the bass and lead Parts as melody Roles. In the Style, the RTAMGS may be configured to include one or more configurations to specify differences between the bass melody Role and the lead melody Role. In an example, the RTAMGS may be configured to use different Part Models. Additionally or alternatively, the RTAMGS may be configured to use the same Part Model with different configuration settings (e.g. a different Part Generator but based on the same Model). In another example, the bass may be generated by the RTAMGS at a lower octave, have a simpler rhythm, and with more chord tones in its melody, based on the difference in the configuration settings of the Part Model.

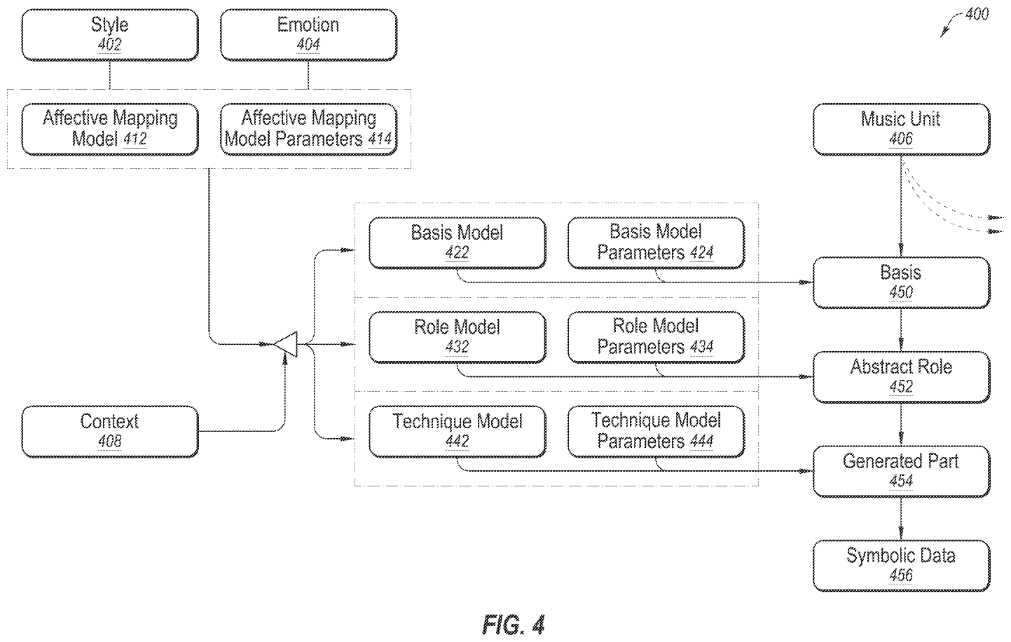

FIG. 4 illustrates an example generation process 400 of a music unit (MU) according to one or more embodiments of the present disclosure. In some embodiments, the Generation Process at the Music Unit Level as illustrated in the above FIG. 4 details how the generation process 400 may work for a given Part. In an example, consider the generation of an ‘Arpeggio’ Part. In some embodiments, given a particular Style 402 (which may have its own configuration settings for each Model) and Emotion 404, a particular set of configuration settings for each of the Models may be defined by Affective Mapping Models 412, and may be stored as Generators. Additionally, during the generation process, a Context object 408 may be created for each of the Generators and populated with the information from the real-time structure that may be needed for the generation process 400 of particular Model.

In some embodiments, the ‘Arpeggio’ Part may be dependent on the harmony Role, which may be dependent on the harmony Basis. The harmony Basis may contain information on how the underlying harmony relates to the key—it may represent the chord in the key with a functional harmony notation, such as “I” for the tonic chord of the key. The harmony Basis may then be stored on a Music Unit node 406 so that other elements of the RTAMGS, including but not limited to other Music Units and other components on the same Music Unit 406 may share that information. An Abstract Role 452 for the harmony may then be generated, which may use the generated harmony Basis as input. The Abstract Role 452 for the harmony may contain information about the actual pitches that the chord contains, such as extensions, inversions, or even absolute pitch sets. The generated Abstract Role 452 for the harmony may then be stored on the Music Unit 406, so that it may also be shared.

In some embodiments, a Generated Part 454 may then be generated, which may use the Abstract Role 452 as input. The Generated Part 454 may contain the absolute representation of notes (as part of its stored and outputted symbolic data 456), which may be similar to that of a digital score, and may also be stored on the Music Unit 406 and may also be shared. The dependencies for each Part may determine which Abstract Role 452 or Roles are used as input. For example, a melody Part Model may specify the Abstract Role 452 for the melody as input, which may also specify the Abstract Role for the harmony as input.

In the embodiment shown in FIG. 4, the generation process 400 is depicted for a Music Unit that has no populated abstract musical objects, such as Abstract Roles, Bases, or Generated Parts. The Music Unit 406 may alternatively include abstract musical objects already populated or refer to a Music Unit 406 that include abstract musical objects already populated. In the case of a cloning of a Music Unit 406, or the repetition of a Music Unit 406, those already-populated abstract musical objects may be used, and those that are not populated may be generated with the existing musical objects as input. In the case of a variation, the existing or referential musical objects may be changed.

It is to be appreciated that one technical advantage that may be realized by the use of abstract musical objects is that the RTAMGS may perform transposition by keeping the same Abstract Role of the melody and changing the Abstract Role for the harmony underpinning it.

In some embodiments, the RTAMGS may be configured to assign at least one Instrument to each of the one or more Parts of an ensemble. In some embodiments, the RTAMGS may be generally configured to define one or more virtual representations of instruments, stored as Instruments, and/or audio effects stored as Effects, used to synthesize one or more chosen Parts within a Cue. An Instrument may be implemented as a container, which may provide all of the information necessary to create the musical audio for a Generated Part or Part, or other musical component.

In an example, an Instrument may define the instrument synthesis type (e.g. sample-based or soft-synth etc.), one or more Parts the Instrument may be available to play (e.g. a piano-like Instrument may play the melody Part, a strummed guitar-like Instrument may play the harmony Part etc.), zero or more parameters, grouped into zero or more presets in order for the same Instrument to produce qualitatively different sounds (e.g. a subtractive soft-synth can produce a sharp lead sound, soft pad sound, deep bass sound etc.), and zero or more preset parameter mappings in order for the presets' parameters to be affected by Emotion changes in the RTAMGS.

A preset parameter mapping may be defined by a minimum value, maximum value, a default value, along with a mapping scale (in some embodiments, linear or exponential) and a link to a parameter within the RTAMGS to map against. Effects may be defined within the RTAMGS as a container for all of the audio techniques that may be applied to an audio stream after the initial audio signal may be generated or the sound source may be loaded (in the embodiments with pre-rendered audio files) for a given musical component.

In an example, an Effect could be applied to the generated audio stream of a Part, after being generated with a particular Instrument. In another example, an Effect could be applied directly to an audio source, such as a pre-rendered audio file. Instruments may have multiple Effects assigned to them.

In some embodiments, a Part may be assigned one Effect that may apply an audio delay to the generated audio of that Part, another Effect that may apply reverb to the generated audio of that Part. The Part may contain information not only for the Effects that is uses, but also the order in which they might be applied.

Furthermore, in some embodiments, Instruments and Effects within the RTAMGS may be generally configured through specification of their Instrument/Effect classification and quantitative/qualitative metadata descriptors with reference to timbre, Emotion, Style and Theme. In an example, a detuned piano-like instrument may be defined by qualitative terms such as “scary”, “horror”, “gothic” etc., along with quantitative features such as attack time, spectral content, harmonic complexity etc.

With continued reference to the above example, the example rock band may include the following assigned instruments: a Drums Part associated with percussion Role and assigned the acoustic drum kit Instrument: YAMAHA Stage, a Bass Part associated with the melody Role and assigned the electric bass Instrument: FENDER Jazz Bass, a Rhythm Part associated with harmony Role and assigned the rhythm guitar Instrument: GIBSON Les Paul, and a Lead Part associated with melody Role and assigned the lead guitar Instrument: FENDER Stratocaster.

In some embodiments, the RTAMGS may be configured with one or more Parts having the same Instrument with different configurations (in an example, using the same instrument synthesizer and different presets). As discussed with reference to the above example, the example rock band may be configured with two electric guitars, where one may be modeled as a rhythm guitar with an arpeggio, one may be modeled as a lead guitar. The RTAMGS may be configured to use two different (AI) Performer Models when processed in the Performance module as further discussed herein. The RTAMGS may also be configured to use Instruments with different synthesizers, where one synthesizer may be a representation of a GIBSON Les Paul and one synthesizer may be a representation of FENDER Stratocaster. In an example, the RTAMGS may be configured to use an instrument synthesizer for the lead Part, which may create a different sound.

Additionally, the RTAMGS may be configured to apply one or more Effects to one or more Parts of an ensemble, such as, in an example, the lead and backing Parts: the Drums Part associated with the percussion Role and assigned the acoustic drum kit Instrument: YAMAHA Stage, the Bass Part associated with the melody Role and assigned the electric bass Instrument: FENDER Jazz Bass, the Rhythm Part associated with the harmony Role and assigned the rhythm guitar Instrument: GIBSON Les Paul, with the Effects: [distortion Effect, reverb Effect], and the Lead Part associated with the melody Role and assigned the lead guitar Instrument: FENDER Stratocaster, with the Effects: [delay Effect, distortion Effect, reverb Effect].

With continued reference to the above example, the composition component/system of the RTAMGS may be configured to assign one or more effects such as distortion Effect and reverb Effect to both guitars, and also assign the lead Part a delay Effect to play with. In some embodiments, the composition component/system of the RTAMGS may also be configured to define what or the type of Effects that may be used on which Part of an ensemble. But configuration settings of those Effects may be determined with the AI Performer Models and by the Affective Mapping Models, as further discussed herein. After Parts, Roles, Instruments and Effects have been defined, the RTAMGS may have a good description of what kind of music to generate.

In some embodiments, the RTAMGS may be configured as a musical system that allows the utilization of AI in a very modular way. The RTAMGS may be configured to leverage AI Models, in an example, for the following purposes: variation, Role generation, Part generation, Instrument and Technique selection (Arrangement), Part-specific Performance generation, Instrument production/synthesis, audio Effects selection and application, generation of configuration settings through Affective Mapping. Additionally or alternatively, the RTAMGS may be configured to generate a musical composition that is self-referential across vertical Parts and may include Parts with musical dependencies on other Parts.

In some embodiments, a large majority of the music generation may be performed by the composition component/system of the RTAMGS. That is, once the composition component/system is finished, the symbolic data of a composition may be almost entirely determined. In some embodiments, after the symbolic data of the composition are determined, the AI Performer Models of the performance component/system may be configured to modify the existing symbolic data based on how a particular Part would be performed on a particular Instrument. Because of this, generation process of the RTAMGS may be closely coupled with the compositional structure of the RTAMGS.

In some embodiments and for every generated structural element in a Musical Theme (examples may include, without limitation, Sections, Phrases, Sub-phrases, and/or Music Units (MUs)), the RTAMGS may be configured to generate and/or otherwise maintain a second structure called a real-time (“RT”) structure. In some embodiments, the RT structure may serve as or be representative of a record for what has occurred in the past. When new elements may be created (in some embodiments, via Structural Generators) by the RTAMGS, the RTAMGS may be further configured to add the new elements onto the structure so that the new elements may be accessed again if or when needed.

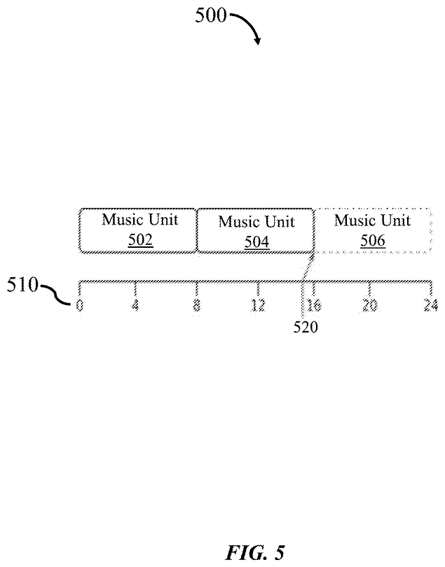

FIG. 5 illustrates an example process 500 of generating a music unit on a MU-by-MU basis according to one or more embodiments of the present disclosure. In some embodiments, the RTAMGS may be configured to perform the music generation process in a lazy fashion, i.e., generate music on an as-needed basis. Stated differently, the RTAMGS may be configured to only perform computations when it needs to and may be configured to anticipate or otherwise predict when a next MU 506 should be generated. In an example, when a Cue is ticked along in beat-time, the RTAMGS may be configured to traverse or move along the structure within a MU, such as MU 502 or MU 504. If or when the next MU 506 is approaching (e.g., one beat before, two beats before, three beats before, etc.) then the RTAMGS may be configured to start generating that next MU 506 as illustrated in the example process 500.

In another embodiment and during the audio playback of an already-generated MU, such as the MU 502 or the MU 504, the Emotion may have changed substantially. In this embodiment and if the Emotion has changed in an example by more than a certain emotional distance threshold, then the MU is replaced in the RT structure with a newly created variation of itself (which may use the new Emotion point as an input). This embodiment may allow for the RTAMGS to generate music that reflects the current Emotion at a more granular level of timing than a Music Unit.

As illustrated in FIG. 5, the RTAMGS may be configured to generate one or more MUs on a MU-by-MU basis. Additionally or alternatively, the RTAMGS may also be configured to generate music on a beat-by-beat basis, or even by smaller time units. Additionally and in some embodiments, the RTAMGS may be further configured to generate each MU on a Part-by-Part basis. In some embodiments, the order in which the Parts are generated may be dictated by the Arrangement and the Role dependencies.

In some embodiments, the arrangement component/system may be generally configured as one or more AI Arrangement Models that may control one or more musical techniques or features. In an example, the one or more musical techniques or features may include, horizontal layering, overall loudness, timbre, harmonic complexity, and/or the like. Typically in musical compositions, subsets of the instruments involved in the musical composition play concurrently. In some embodiments and in the context of the RTAMGS, the same may also be true. In some embodiments, the one or more AI Arrangement Models of the RTAMGS may be configured to receive, as input, an Ensemble, Emotion, and/or current Arrangement. In that embodiment and based at least partially on the received Ensemble, Emotion, and/or current Arrangement, the one or more AI Arrangement Models may be configured to determine what Parts and/or Techniques should be playing next.

The musical component that may be used to store this information is the Ensemble. The Ensemble may store all of the available Parts, which may in turn determine, in an example, the available Instruments, Techniques, and Generators that are available for the given musical piece. When the Arrangement Model determines what Parts should be playing next, it may store the selected subset of the possible Parts in an Ensemble and store them as Active Parts on a given Music Unit. With the Active Parts defined, a Music Unit may know what Parts need to be generated.

The example process 500 may facilitate creating a system that generates music in real-time as needed, based at least partially on the next Music Unit 506 or otherwise a small chunk of time. Additionally or alternatively, the example process 500 may facilitate creating an AI that controls musical techniques or features including, in a non-limited example, horizontal layering, overall loudness, timbre, harmonic complexity, or some combination thereof.

In some embodiments, the RTAMGS may include AI control units which may be generally configured to determine which Generators to use for certain musical or structural elements. The AI control units component/system may also be configured to modify the selection and configuration of all Generators, including (in an example) structure, Roles, Parts, Performers. In some embodiments, the AI control units can be realized as Affective Mapping Models and Arrangement Models.

The RTAMGS may be configured to also define Affective Mapping Models. Affective Mapping may be defined as the translation of emotional scenarios into the necessary musical parameters that inform the generation of music that elicits that particular emotion from the music listener. The RTAMGS may be configured to input a Style and an Emotion into an Affective Mapping Model, as well as some Affective Mapping parameters, to create an Affective Mapping Generator. The Affective Mapping Generator may output the configuration settings for all the Generators of a given Style, as realized in the given Emotion. Those Generators may then be used in the RT structure to generate music in the given Emotion and Style.

In some embodiments, when a Generator is called to generate a musical object during the generation process of a Music Unit, the generated musical object may be stored in its own cache on the Music Unit. This way, if or when one or more musical objects of a MU is repeated or varied, the RTAMGS may not need to do much computational work to repeat the one or more musical objects of the MU. In some embodiments, when a MU is repeated, but the arrangement has changed, then the RTAMGS may be configured to use (or configured to only use) the new arrangement, and the one or more Generated Parts may be retrieved from the cache or generated as needed.

The RTAMGS may use a custom architecture design that allows for the complete de-coupling of the generation process for Generators. The RTAMGS may define a Context object, which may be populated with some or all of the necessary information that may be used by a particular Model for the generation process. This may include: structural context, which may be defined as the location within the musical structure for the structural element being generated; musical context, which may be defined as all of the abstract or absolute musical objects that may be used for the generation of the given musical object (in the case of a melody Part, in some embodiments, this may include the Abstract Role for the harmony of the current Music Unit, the Abstract Role for the melody of the current Music Unit, as well as the structural context). The Context object may be configured to have a particular window size, which may define the number of Music Units 502, 504 prior to the Music Unit 506 using the current Generator that the Generator may use to inform the generation of the objects on the current Music Unit 502, 504.

In some embodiments, a melody Part Model may generate a Generated Part, which may be a monophonic sequence of notes. In that embodiment, the melody Part Model may reference the abstract harmony of the previous Music Unit, as well as the Generated Part for the melody of the previous Music Unit, which would mean that the window size for the Context may be set to 1. In another embodiment, a Role Generator for the harmony may reference the Abstract Role for the harmony from two previous Music Units, in which case the window size for the Context may be set to 2. In addition, the Role Generator for the harmony may reference information about where the Music Unit is in the current Sub-Phrase or Phrase, in which case the structural context may provide that information. In both embodiments, the Context object may be created, and the corresponding information may be collected before the Generator is called on to generate a musical object.

Each Model may define its own parameters, which may include the Context object, as well as other pertinent information. In some embodiments, a Part Model for the melody may specify the octave that it should be generated in and the pitch range within which it should generate all its notes. The Part Generator may gather the information based on the current settings and provide that information to the Part Model when generation occurs.

Each Model may also have configuration settings that inform the generation process. When the set of parameters are configured for a Model, a Generator may be created to store that configuration. It is to be appreciated that one technical advantage that may be realized by this is that a Model to be used for multiple Styles, in some embodiments by training that Model on a dataset of music that is in a new Style, and making multiple trained parameter sets available through a Model parameter. In some embodiments, a Markov Harmony Model could use the set of transition probabilities determined from a dataset of Rock songs, or from a dataset of Piano songs, depending on the ‘dataset’ parameter as defined in the configuration settings. The configurations for any Model may be changed for any Style configuration and may be changed at runtime.

Basis Models may be the machine-learning models that are designed to generate a Basis for a particular Role. In an example, Basis Models may be trained on a dataset for a particular Style, Instrument, or other musical feature. Basis Models may then be used as part of a Generator to generate a Basis for a particular Role in a particular Music Unit, which means that the Basis Model may generate the specific format of the Basis object defined for that Role. There may also be multiple types of Basis objects for a particular Role designation, which may be influenced by the particular method that the Basis Model uses. In some embodiments, a Basis Generator for the melody Role may use a probabilistic tree machine-learning model to generate an arpeggio for an abstract triad, and then specify that the Basis object store that abstract arpeggio. This embodiment may create a different type of Basis than other Basis Generators, even if they generate a Basis for the same Role (in this embodiment, the melody Role). Basis Generators may also take Basis representations from data, and use them directly in the generation process, rather than generate the Basis from scratch.

Role Models may be the machine-learning models that are designed to generate an Abstract Role for a particular Role. In an example, Role Models may be trained on a dataset for a particular Style, Instrument, or other musical feature. Role Models may then be used as Part of a Role Generator to generate an Abstract Role for a particular Role in a particular Music Unit, which means that the Role Model may generate the specific format of the Abstract Role object defined for that Role. There may also be multiple types of Abstract Role objects for a particular Role designation, which may be influenced by the particular method that the Role Generator uses.

In some embodiments, Technique Models may be generally used by Parts, in order to generate the notes based on a particular instrumental technique. Technique Models may also be AI modules that may be trained on a particular set of data and may be used as part of a Part Generator in order to generate a Generated Part using a musical technique. The Part Generators may be different from the Role Generators, because the Part Generators may contain a set of Technique Models that the Part Generator may use, and Technique Models may contain sub-techniques that the Technique Model may use, and the particular sub-Technique used may be changed by the Part Generator itself. The Technique Models may use the abstract objects that may be stored on a Role component and generate a new set of symbolic data that may be guided by those abstract representations. Part Generators may be configured to allow for the consideration of particular constraints on a Part. Different Instrument Models may be configured to guide some aspects of the Part generation (in an example, chord voicing and/or pitch range).

In some embodiments, a Part Generator could be created in order to generate an arpeggio. The Part Generator may use multiple different Technique Models, each of which may represent a different type of arpeggio: in one embodiment an Alberti Bass arpeggio pattern for which the notes jump from the root, to the fifth, to the third, and back to the fifth of the chord. In another embodiment, the Technique Model may contain the information necessary to create a Generated Part that contains the symbolic note information for two separate hands of a piano instrument Part. In both embodiments, the Techniques may have sub-techniques which may define different versions of the containing Technique. In an example the Alberti Bass arpeggio pattern could have many sub-patterns which can be used for different musical scenarios.

In some embodiments, these Technique Models may be grouped so that there may be many Technique Models for a particular Part because a particular instrument may utilize multiple different compositional techniques to compose a Part for that instrument.

Generators may not only be restricted to the Composition component/system. Performer Models (sometimes referred to as “Performers”) may be defined as Generators that modify an existing musical object or set of symbolic data. In some embodiments, a Performer Model may apply timing and velocity changes to an existing set of notes, to make the set of notes sound more natural, which may sound more like a human performance.

In some embodiments, the RTAMGS may be configured to include one or more Variation Models that include, without limitation, one or more Structural Variation Models, one or more Basis Variation Models, one or more Role Variation Models, and/or one or more Part Variation Models.

In some embodiments, a Variation Model may simply be applied to the Abstract Role, using a Role Generator to re-generate the Abstract Role of the harmony. In this embodiment, that may have the perceived effect of transposition, as the Abstract Role of the melody depends directly on the selected harmony that underpins it and may thus be re-generated. It is noted that the transposition described in this embodiment may not be realized in symbolic data (and thus the digital musical score may remain unchanged) until a Generated Part is re-generated.

It is to be further appreciated that due to the Role dependencies in Parts, some or all of the Parts may need to be regenerated by the one or more Variation Models as a result of the variation. In a continuation of the previous embodiment and because of the adherence to dependencies between Roles and Parts, any Part that depends on any newly generated Role will also be re-generated, thus realizing the transposition by generating symbolic data with the Part Generator and storing it as a Generated Part.

In some embodiments, a harmonic variation in which the chord is changed may result in all harmony and all melody Parts being re-generated, as the melody Role may depend on the harmony Role, and each Part may depend on the newly generated Roles. In the same embodiment, however, the Parts that depend on the percussion Role may remain unchanged, since the percussion Role may not have been re-generated. In that embodiment, the cache of Generated Parts on the Music Unit that was varied will be used to pull in the Generated Part, for any Part that depends on the percussion Role.

In some embodiments, the RTAMGS may be generally configured to generate music with the meter having various time signatures (e.g., 2/4 march time, 3/4 waltz time, 4/4 common time, etc.). In some embodiments, the RTAMGS may be configured to generate music with varying rhythm and meter by utilizing Rhythmic Models, which may generate specific rhythms while keeping the metrical information in consideration.

In some embodiments, the RTAMGS may be configured to define a Rhythm Model that uses one or more rhythmic templates to represent one or more rhythms. In one example, rhythmic templates may be defined as a list of durations, e.g., [8.0] is a breve and [1.0, 1.0] is two crotchets. Rhythmic templates may be further specified per Part in the Style configuration as Generators. The example is not limited in this context.

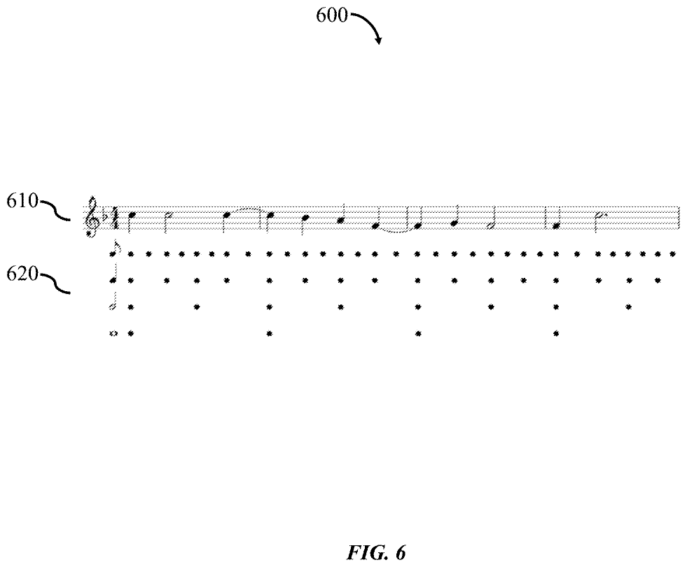

FIG. 6 illustrates an example of a metric level dot notation 600 for representing musical rhythms according to one or more embodiments of the present disclosure. One embodiment of a particular Rhythm Model may be the Metric Fingerprint Model. A Metric Fingerprint may be defined as the abstract rhythmic patterns of a monophonic musical Part.

Metric levels may be described in a dot notation 620 corresponding to music notes 610. The higher the metric level, the more important that onset is in the current metrical framework. It follows from the idea of modeling meter as a hierarchy of more or less important onset times. Metric levels may be defined by counting the number of dots in the dot notation and assigning that level to the onset.

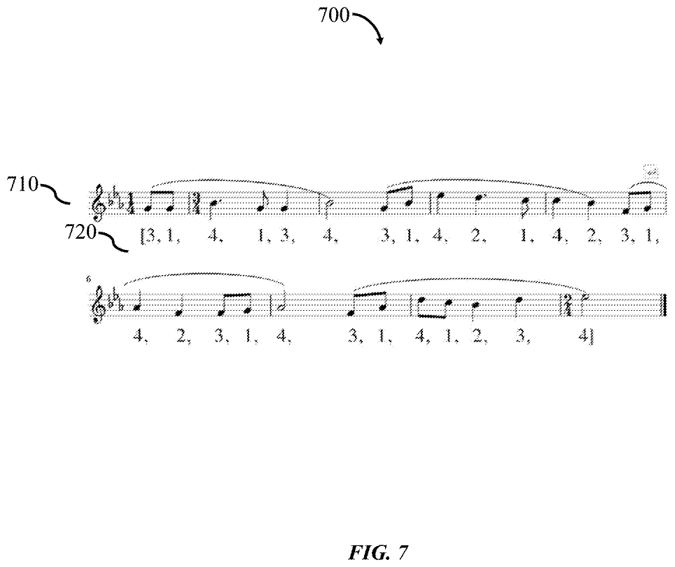

FIG. 7 illustrates an example song 700 with labeled metric levels according to one or more embodiments of the present disclosure. In the metric level dot notation 600 of FIG. 6, for example, the 1st bar follows a metric pattern of: [4, 1, 2, 1, 3, 1, 2, 1] at the ⅛th note level. Metric levels may be defined for different metrical signatures and, in some embodiments, different Styles. The example song 700 may include music notes 710 that correspond to a metric pattern 720.

In some embodiments and using machine learning, the RTAMGS may be configured to extract Metric Fingerprints from one or more databases containing one or more musical scores and reduce the one or more musical scores to small units of rhythmic figures. In some embodiments, the RTAMGS may be further configured to apply the extracted Metric Fingerprints as a fundamental unit in one or more rhythmic patterns, and then generate full rhythmic sequences by making embellishments (with particular AI rhythmic embellishment models as well). In some embodiments, Metric Fingerprints may create a sense of rhythmic coherence in a piece of generated music, which may be similar to mini rhythmic motifs and variations.

In some embodiments, the RTAMGS may be configured to perform the method of extraction by extracting patterns from a metric level sequence. In an example and with reference to FIG. 7, the metric patterns 720 in the notated metric level sequence may be considered to be [3,1,4] and [4,2]. In some embodiments, the RTAMGS may be configured to identify the important (or even most important) repeated patterns of a number sequence utilizing a formula. Moreover, the RTAMGS, utilizing the formula, may be configured to identify the important repeated patterns based on the number of times that the pattern repeats, the length of the pattern, and the amount the pattern may overlap with itself, and possibly the size of the metric levels in the sequence.

In an example and with reference to FIG. 7, the RTAMGS utilizing the formula may be configured to automatically extract the patterns [3,1,4] and [4,2] from the above sequence, and mark them as important patterns. The RTAMGS may be configured to first pre-process the sequence of metric levels, such that the sequence is modified to remove any metric level below a certain threshold. In an example, the metric level threshold could be set to 2, such that the full metric level sequence on which the extraction is executed is [3, 4, 3, 4, 3, 4, 2, 4, 2, 3, 4, 2, 3, 4, 3, 4, 2, 3, 4], and the important metric level patterns extracted from that sequence are [3,4] and [4,2]. In some embodiments, these extracted patterns may be termed as Metric Fingerprints, and may subsequently be used in the generation of rhythms by way of embellishing (in an example, adding more onsets) the rhythmic sequence while maintaining these metric levels in the final sequence.

One technical advantage that may be realized with the use of Metric Fingerprints is the ability to share rhythmic stresses across one or more Parts. For example, the bass and the kick drum may work together, the lead and counter melody may complement one another. In an example implementation, the RTAMGS may be configured to store one or more Metric Fingerprints in a Metric Fingerprints cache, which may be modified and/or transformed in different ways by the RTAMGS. This Metric Fingerprint cache may be stored on the real-time structure at the root level, such that the Metric Fingerprint can be accessed and re-used for any structural element in the currently generated piece.

The RTAMGS may be configured to create rhythmic coherence by utilizing rhythmic templates and/or Metric Fingerprints. The RTAMGS may be further configured to generate coherent rhythmic patterns that automatically contain self-referential material but do not repeat exactly, relate to the metric signature of a piece (for any metric signature), build up full rhythmic patterns based on fundamental building blocks (Metric Fingerprints), or some combination thereof.

In some embodiments, the Performance Component/System may take as input all of the configuration settings including but not limited to all of the User Scenario information (defined below) such as Style, Emotion or emotional trajectories, parameter mappings, etc., as well as musical information and configurations that may in part be defined by the User Scenario or also generated, including but not limited to Parts, Roles, Ensembles, Generators, Models, etc. In addition, the Performance Component/System may also take the output symbolic data from the Composition System, as well as the Real-time Structure of the current generation. This information is used for the generation of the output format.

In some embodiments, the Performance component/system modifies the symbolic data that may be received from the Composition component/system, in order to specify not only what music is to be played, but also how each Instrument may play the music. Its output may include the modified symbolic data, as well as data that relates to specific Instruments such that audio may be generated that may represent a realistic approximation of how a human might perform the music contained in the symbolic data. In some embodiments, the symbolic data output by the Composition component/system may be represented as an integer value, a string, or some combination alphanumeric symbols such that receiving the symbolic data by the Performance Component/System results in the Performance Component/System reproduces the same audio regardless of which Composition component/system originally generated the symbolic data.

In some embodiments, the Performance component/system of the RTAMGS may be generally configured to add expression into the generated music using one or more Performer Models. For example, the same piece on the same Instrument generated by two different AI Performer Models may sound and feel different in various aspects. In an example, the AI Performer Models may be configured to add articulation, play with dynamics, expressive timing, and Instrument-specific performance material via Instrument control messages (e.g., strumming, picking, slides, bends, etc.). The examples are not limited in this context.

In some embodiments and to add expression into the generated music, the RTAMGS may be configured to assign one or more Parts to one or more Performer Models. The one or more Performer Models may be configured to control how one or more aspects of a performance may be performed. This may include, without limitation, articulation, strumming, dynamics, and/or the like. In one example and to create an expressive piano performance, the one or more Performer Models of the RTAMGS may be trained on piano music, and the one or more trained Performer Models may then be applied to modify the dynamics and expressive timing of the composed Part. The RTAMGS may be configured to create human-like (or even superhuman) performances from existing compositions.

In some embodiments, the production component/system may be generally configured to synthesize the music the RTAMGS creates, which in turn generates the output audio. In some embodiments, the operations performed by the production component/system may be the final stages of the music generation process. In some embodiments, the production component/system may further be configured to perform one or more operations which may include, without limitation, Modeling, Sequencing, Signal Processing, and/or Mixing.

In some embodiments, the modeling operations may generally generate music using one or more synthesizers and optionally apply one or more Effects to an output audio stream. Moreover, by the time the RTAMGS has completed the various operations associated with the composition component/system and performance component/system, the RTAMGS may have already determined what Instruments are playing for which Parts. However, the sonification itself may utilize at least one synthesizer (“synth”), and optionally one or more Effects to produce an audio stream.

In some embodiments, the one or more synths and/or one or more Effects may be associated with one or more parameters. Furthermore, these parameters may have different units, accuracy, scales, and/or ranges. In an example, a delay Effect may modify delay time and feedback parameters. Additionally, the delay time parameter on the delay Effect may also be represented in milliseconds, as a whole number, in a linear scale and may range from 0 to 2000. In another example, a low pass filter cutoff parameter of a synth may be represented in Hertz, as a fractional number, in an exponential scale, with a range from 20 to 22000. The examples are not limited in their respective contexts.

In some embodiments and with respect to the RTAMGS, the one or more synths may be primarily represented as data stored in a data store. Thus, the one or more synths kept separately from the various components/systems (e.g., main code implementing the various components/system), because the one or more synths may mainly contain data. In some embodiments, an Instrument manifest may define all of its parameters, which may be mapped and hooked up automatically by the RTAMGS. In some embodiments, the Style may also contain one or more additional configurations for these parameters. In an example, in Medieval Style, it may be undesirable for the reverb Effect to go on for too long of a time period, but in Minimal Piano Style it may be desirable to have longer reverbs or even the longest reverb possible.

In some embodiments, the sequencing operations may generally sequence one or more musical events. Moreover, sequencing may refer to the process of taking one or more musical events, putting them on a timeline, and then triggering them at the right time. The RTAMGS may be configured to change musical and Instrument parameters in real-time (e.g., tempo, Instrument settings). For example, the sequencing component may be configured to handle the following musical events:
Tick event: A beat tick event, in some embodiments, 24 ticks per quarter note (tpqn)
Beat event: An event fired every musical beats per minute (bpm) beat
Bar event: An event fired for every musical bar
Note onset event: A note onset event which may include, without limitation, pitch (MIDI number) and velocity information.
Note offset event: A note offset event for a specific pitch.
Param change event: A parameter change event for changing volume, panning, or a synth/Effect parameter as well as Emotion changes.
Complete event: A complete event that may be fired when a Cue ends.

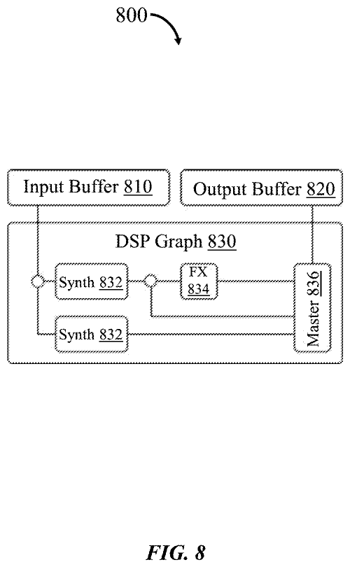

FIG. 8 illustrates an example environment 800 that includes a Digital Signal Processing (DSP) graph 830 that may be implemented as part of a synthesis component of the RTAMGS according to one or more embodiments of the present disclosure. In some embodiments, the processing operations may generally generate and output music to an output buffer utilizing the DSP graph 830 within the synthesis component of the RTAMGS (see FIG. 1). To facilitate the processing operations, the one or more applications and/or host system may provide the RTAMGS with input buffers 810 and output buffers 820. In some embodiments, the DSP graph 830 as illustrated in FIG. 8 may include, without limitation, a network of one or more synths 832 and effects, where the inputs and synths and effects (illustrated and labeled as “FX 834” in FIG. 8) are operatively coupled together directly, indirectly, and/or via sends. In some embodiments, the DSP graph 830 as illustrated in FIG. 8 may further include, without limitation, a master channel 836 operatively coupled directly and/or indirectly to the one or more synths and/or effects. In some embodiments, the DSP graph may be configured to write the output back to the output buffer.

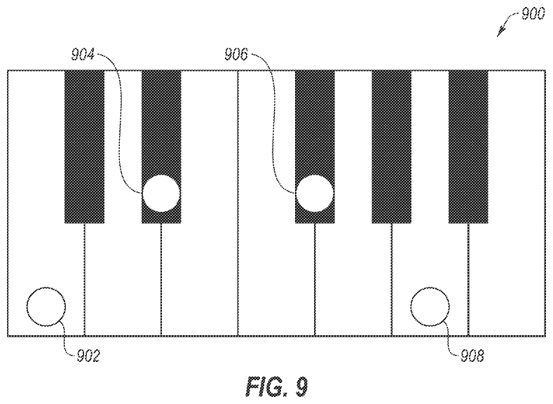

In some embodiments, the one or more synth 832 may include, without limitation, two types of synth—sample banks or soft-synths. In some embodiments, the sample banks may include a collection of small pre-synthesized audio files, sampled per note and velocity level. In an example, sampling may be performed every three semi-tones, as depicted with the red dots in FIG. 9, to reduce the size from 12 notes to 4 (per octave). Pitch-shifting may also be used to recreate the other notes, In the embodiment in which notes are sampled every 3 semitones, a pitch-shifting distance of only one semitone is necessary in order to recreate every note in an octave.

For example, FIG. 9 illustrates an example reduced set of samples 900 for generating music notes corresponding to a particular octave according to one or more embodiments of the present disclosure. In the reduced set of samples 900, every note illustrated without a red dot may be at most one semitone away from a note with a red dot 902, 904, 906, or 908. In some embodiments, velocity levels may be sampled at a number of different resolutions, depending on the desired sound of a particular Instrument.

In some embodiments, soft-synths may be computed on-the-fly, and thus, may use additional CPU time to generate and output music to an output buffer. The RTAMGS may be configured to provide a fully embeddable production system. Additionally or alternatively, the RTAMGS may be configured to control the tradeoff between CPU time and memory size based at least partially on whether synths or sample banks is selected for use.

In some embodiments, certain AI modules (or Models) will span multiple systems, in an example the Composition and the Performance System. In that example, the model will not only generate the notes that are to be played, but also the nuances in timing and instrumental performance information such that the Generated Part can be shared directly with the Production Component/System to be sonified to create audio that includes both compositional and performative characteristics.

One such example of a Model that spans multiple Components/Systems is what may be named the Midi-to-Audio Synthesis (MTAS) model. Based on deep learning, the model is able to first generate the instantaneous pitch values over the desired time period, as well as the instantaneous loudness, based on the parameters of a sequence of Note objects (each of which may include but is not limited to pitch, onset, duration, accents, bar, dynamics, etc.). Those instantaneous pitch and loudness values can then be fed into a synthesizer trained on a neural network to generate instrumental audio from instantaneous pitch and loudness curves. In one example, the synthesizer that can receive instantaneous pitch and loudness could use Differentiable Digital Signal Processing techniques. The MTAS model can also be configured to use the MIDI note standard (into which the RTAMGS can be configured to convert its custom note object) as a direct input into the synthesizer, with additional MIDI control metadata that can inform the synthesizer to add performance and intonation characteristics to the synthesized audio.

For example, an interim output of the MTAS model when trained on an audio dataset of a transcribed violin performance may be plotted in which an input is represented as pitch-to-Hertz values and velocity-to-decibals loudness values. The inputs may represent the MIDI input to the MTAS model. The interim output of the MTAS model may output a “target” pitch or loudness curve that is typically represented as a solid line with fluctuations. This represents the pitch and loudness curves of the instrumental violin performance of those MIDI inputs (represented by pitch-to-hz and velocity-to-dBA values). Predicted values for both pitch and loudness may be output by the MTAS model created using a deep learning model, which can then be synthesized by another deep learning synthesizer to create the resulting violin performance audio.

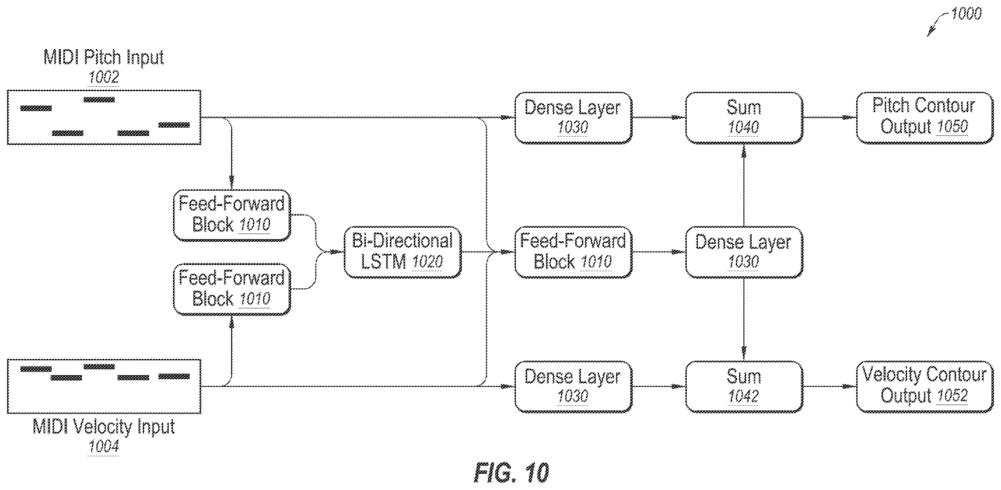

FIG. 10 illustrates a training process 1000 of a MTAS model according to one or more embodiments of the present disclosure. The MTAS model may use a neural network architecture that centers around a bi-directional Long Short-Term Memory (LSTM) block 1020, and involves Dense Layer blocks 1030, which themselves include a dense layer, a layer normalization, and a Leaky Rectified Linear Unit (ReLU) unit, that may facilitate the training speed. A MIDI pitch input 1002 and a MIDI velocity input 1004 may be passed through one or more feed-forward blocks 1010, the bi-directional LSTM block 1020, and one or more of the Dense Layer blocks 1030 to formulate one or more sums 1040.

In one embodiment, the training dataset contains single track audio recordings in way or mp3 formats and their corresponding f0 contour, note and MIDI annotations. The MTAS model described in relation to FIG. 10 may involve continuous MIDI pitches 1002 and MIDI velocity contours 1004 as inputs and output f0 and loudness contours, such as pitch contour output 1050 and velocity contour output 1052.

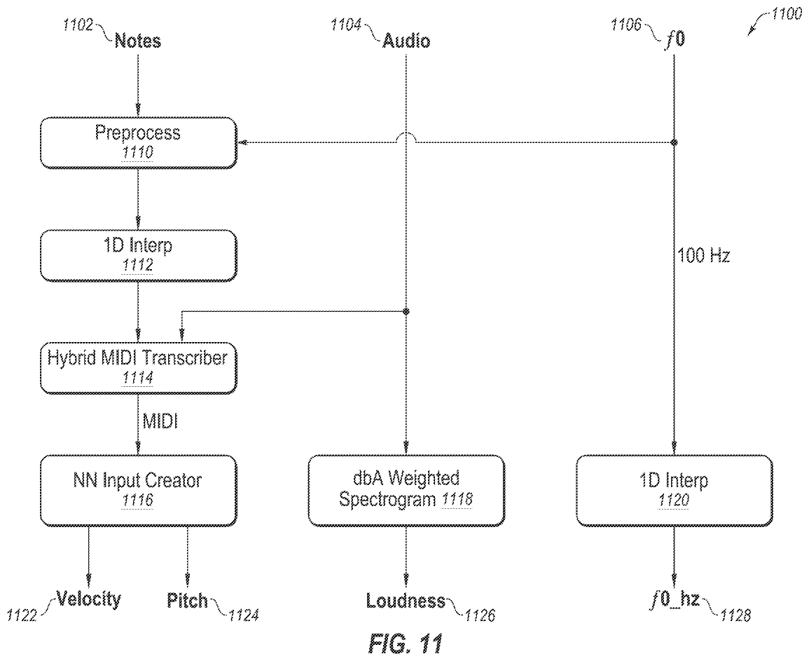

FIG. 11 illustrates an example process 1100 of preparing training data for the MTAS model according to one or more embodiments of the present disclosure. The results are both instantaneous MIDI velocities 1122 and MIDI pitches 1124, a target loudness 1126, and a target pitch (labeled as “f0_hz 1128” in FIG. 11) that the MTAS model can use to evaluate its generated loudness and pitch contours. An f0 contour 1106 provided with respect to the dataset represented in the example process 1100 is extracted with 100 Hz frame rate. Since the MTAS model uses inputs at 250 Hz frame rate, the f0 contour 1106 may be up-scaled using 1D Interpolation 1120. Afterwards, the loudness feature may be extracted from audio 1104 using a dbA weighted spectrogram 1118, now directly at 250 Hz frame rate to get the target f0 curve. Even though the dataset contains the MIDI annotations of the compositions, inconsistencies may exist in them in terms of extra notes, missing notes and alignment problems. In order to deal with these issues, a hybrid MIDI transcriber 1114 may be used, with which one or more note boundaries and one or more loudness extractions may be adjusted. Starting with preprocessing note annotations 1102 at a preprocessing block 1110, one or more note annotations 1102 that are too short to be considered a real note may be removed and monophonicity may be enforced by eliminating short overlaps between consecutive notes. After verifying the annotations, the annotations may be up-sampled to the new sampling rate using 1D interpolation 1112. The corrected note boundaries and the extracted loudness contour may be used to estimate the MIDI velocity of the notes. Since the MIDI pitches are available, a neural network input creator 1116 may obtain the MIDI properties as inputs and output the MIDI velocity 1122 and/or the MIDI pitches 1124. The loudness values may be mapped to MIDI velocities with min-max normalization or standardization. With this process, the f0, loudness, MIDI pitch and MIDI velocity may be obtained for the complete duration of the compositions. In order to deal with the receptive field of the neural network in the MTAS model, these contours may be cut into four-second long frames using a joint splitting process. The joint splitting process will remove a note from the following frame if a note exists at the frame boundary.

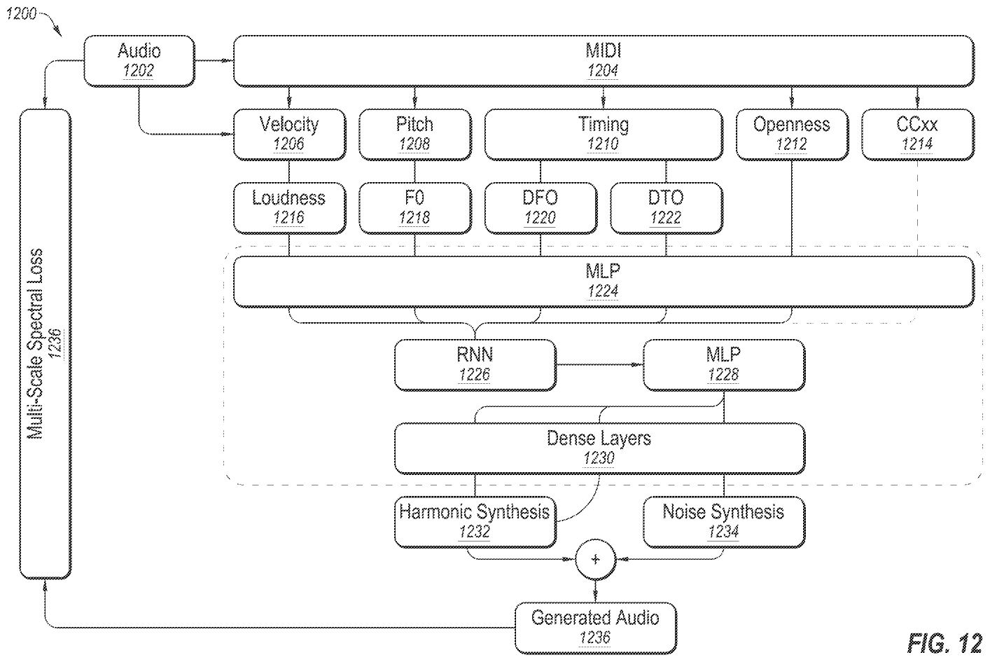

FIG. 12 illustrates an additional or alternative training process 1200 of the MTAS model according to one or more embodiments of the present disclosure. In these and other examples, a MTAS model can be created that modifies the differentiable digital signal processing architecture to receive MIDI control information directly. The training process 1200 of the MTAS model may involve decomposing audio 1202 and a corresponding MIDI 1204 into various components, such as a velocity 1206, a pitch 1208, a timing 1210, an openness 1212, and/or one or more arbitrary continuous controller (CC) values 1214.

In other words, audio may not be directly used to produce inputs to the decoder. Instead, MIDI annotations are used to generate fundamental frequency curve (labeled as “FO” 1218 in FIG. 12), loudness 1216, additional timing signals (e.g., distance from onset or distance to offset), and the arbitrary continuous controller (CC) values 1214. CC values are used to capture various performance characteristics such as “openness”—the degree of how muted the guitar string is when plucked. Additional inputs are passed through dedicated stacks of dense layers, such as a first MultiLayer Perceptron (MLP) layer 1224, a Recurrent Neural Network (RNN) layer 1226, a second MLP layer 1228, and/or any other dense layers 1230. The resulting harmonic synthesis 1232 and noise synthesis 1234 may be combined to produce generated audio 1236, which may be compared to the input audio 1202 as a multi-scale spectral loss 1238.

In an example, a machine-learning based violin virtual instrument can be created with the MTAS model (“the MTAS violin”), such that the RTAMGS can use the Composition Component/System to determine the notes that the violin should play, and the MTAS violin model can take those notes, and directly synthesize instrumental violin audio with performance characteristics. The resulting audio would skip the Performance Component/System and be input directly into the Production Component/System as a finished audio track. Other Production System processes such as, in an example, Mixing and the application of effects can still take place on the resulting synthesized violin audio, but the violin audio itself may not need to be synthesized.

In an example, a machine-learning based guitar virtual instrument can be created with the MTAS model (“the MTAS guitar”) by training directly on monophonic guitar performance audio. With the MTAS guitar, it is also possible to use MIDI control metadata to tell the model when it should generate guitar notes with different performance attributes. In the example of the MTAS guitar, it can be configured to generate regular plucked guitar sounds, or to generate palm muted (a guitar performance technique that affects the resulting timbre of the audio) guitar sounds. This technique can be extended to isolate many musical performance attributes, such as but not limited to vibrato, bends, glissando, finger-picking, squeals, accents, etc.).

In some embodiments, the RTAMGS may be generally configured to use a very efficient mixing method, based on Parts. In an example, a Part may be annotated with its mix presence, which may then be used to create a balanced mix across the Parts.

In some embodiments, the RTAMGS may be generally configured to utilize ambisonic techniques for creating immersive 3D sound mixes. In an example, the RTAMGS may synthesize and mix the audio in a 1st-order ambisonic space and output the synthesized ambisonic audio buffer back to the host system.

In some embodiments, the RTAMGS may be generally configured to utilize spatial audio techniques for placing sound sources in 3D space and in so doing create diegetic mixes. In an example, the RTAMGS may create one or more sub-mixes of one or more synthesized Instruments. Each sub-mix may be output on their own isolated audio buffers, which may then be spatialized by the host system.

Given that the RTAMGS may be configured to generate music in particular Styles, and that the configurations may describe generative models for one or more layers of abstraction of the music, the RTAMGS may also be configured to support the generation of mash-ups of two or more musical Styles. This may be done by combining the different Parts and corresponding Models from the different Styles in a new Style configuration.

In an example, there may be a Style named “Electronic Dance Music” (EDM). The RTAMGS may have multiple machine-learning Models that have been created for generating EDM music, and the EDM Style may define the specific configurations for each of those Models, such that the music generated may be recognized as music in the EDM Style. The same may be true for a “Medieval” Style. To create a Mash-up, a Style may define a configuration that takes, in some embodiments, the Role Generator for the harmony of the EDM Style, and the Part Generator for the melody of the Medieval Style. In an example, this could manifest in the generation of a Medieval-Style melody (perhaps synthesized on a traditional Lute Instrument) that may fit the EDM harmony that has been generated.

In some embodiments, the one or more Styles may be realized by a set of configuration settings, which may include but is not limited to the definitions and parameters/settings for the musical Models (in an example for Arrangement, Bases, Roles, Parts, Performers, Structure, Variation, and Affective Mapping) corresponding Generators and the data or datasets needed for Models, Parts, Roles, Part and Role dependencies, Ensembles, Instruments, Effects, and Production settings. In some embodiments, the Style may also include more general musical information that pertains to the desired musical style, in an example features like tempo, pitch range, common scales, rhythmic information like melodic and harmonic rhythmic density, rhythmic grooves, and metric accent patterns and/or fingerprints.

In some embodiments, the Style may specify one or more music Models that may be used for the creation of each musical aspect. Additionally, one or more Styles may also implement their own Models if some specific behavior is specified by the user. In an example, the “Medieval” Style may specify that a Markov chain Model may be used to create the harmonic structure in the music, whereas the “Epic” Style may specify that a neural network Model (NN) may achieve the same task. Continuing with this example, the NN Model may be a more complex and flexible model, which may suit the “Epic” Style but may be excessive and therefore wasteful of computational resources for “Medieval” Style music, which may only include a simple harmonic progression.

In some embodiments, the Style may also set the parameters of each music Model used, so that if an ML music model requires training, the training may be performed before in an offline environment, with access to the training data it needs. After training, the Style may then contain the learned parameters, which may be used to initialize the Model and create a Generator. In some embodiments, the Style may be input as a high-level parameter into the RTAMGS (e.g., “ambient”, “edm”). In some embodiments, a Style within the RTAMGS may be a collection of configuration parameters. In an example, the collection of configuration parameters may specify what Instruments are available, what tempo ranges there are, what Parts should be generated. It is to be appreciated that some or even almost every part of the composition component/system may include some parameters defined by the Style.

In some embodiments, the RTAMGS may be generally configured to define a Cue. In some embodiments, a Cue of the RTAMGS may be a basic Musical State or User Scenario. In some embodiments, a Cue may include a specific Style, an initial Emotion, and/or one or more Musical Themes. In some embodiments, the Style may define how the music may be generated by the RTAMGS, by defining, in an example, the available Parts, Roles, Instruments Effects, AI Models, Generators, and Ensembles. In some embodiments, Styles may be given easy-to-understand names such as, for example, “Medieval”, “Rock”, and “Epic”. Pieces generated in the same Style may share similar musical characteristics such as choice of harmony, instrumentation and rhythms. In an example, the music generated in the “Medieval” Style may resemble that which is commonly found in fantasy RPG games like the ZELDA game series published by NINTENDO Co., Ltd. Thus, in some embodiments, the Style may control some or even all aspects of the music from composition, through performance, and into production.

In some embodiments, and as discussed above, a Cue may also include one or more Musical Themes. The RTAMGS may perform the real-time generation process within or with respect to a Cue. To perform the real-time generation process, a Cue may include at least one Musical Theme. If at least one Musical Theme is not given or selected by a user, the RTAMGS may be configured to generate a Musical Theme in real-time. During initialization, the RTAMGS may be configured to clone a Musical Theme's structure into the RT structure, so that the Cue is ready to start generating, and the first MU is generated. If more than one Musical Theme is given, the RTAMGS may perform more preparatory computations and operations before cloning the Theme (or Musical Theme mash-up) into the RT structure.

In some embodiments, the RTAMGS may be configured to generate music based at least partially on at least one Musical Theme (or otherwise referred to as “Theme”). In some embodiments, one or more Musical Themes may be defined as containers of abstract music content that may be implemented in different Styles and/or Emotions. In an example, Musical Themes may contain structure (as a hierarchy of structural elements) and may be between 4 and 16 bars in duration, in total. Continuing with the example, the Musical Themes may also contain abstract musical content. The abstract musical content may include, without limitation, an abstract harmonic progression, an abstract melody line, a set of metric fingerprint, and/or a cache of generated embellishments for rhythm and melody. In some embodiments, a Musical Theme may be a musical idea, which may be used in multiple ways by the RTAMGS when generating music. In an example, the same Theme may be implemented in a different Style, Emotion or key signature/mode, or even broken apart and combined with another Theme.

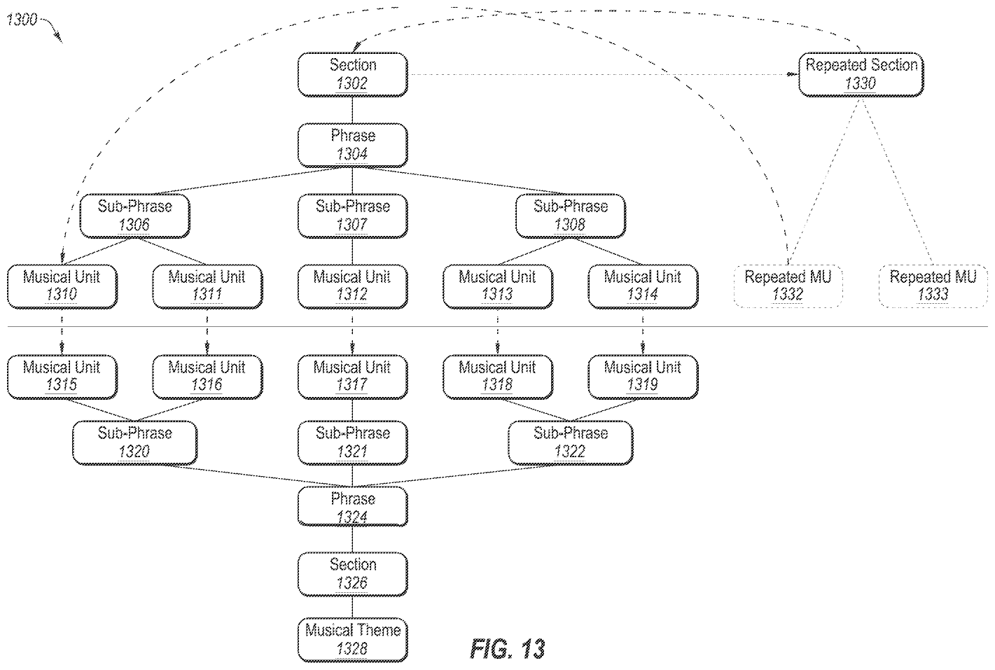

FIG. 13 illustrates an example process 1300 of generating a musical theme using a real-time repetition structure according to one or more embodiments of the present disclosure. Given a Musical Theme 1328 (perhaps as part of a Cue), which may have a defined structure and musical information in each Music Unit 1310-1314, the real-time structure may first clone the structure of the Musical Theme upon the instantiation of a Cue. The structure may be copied from the top-most level of the structure of the Musical Theme, (in the example process 1300 depicted in FIG. 13, at a Section level 1302). Then, each structural element in the RT structure may reference each individual structural element in the Musical Theme 1328. Two embodiments of the created references are shown by the connection between a repeated section 1330 and the section 1302 and by the connection between a repeated MU 1332 and 1333 and the MU 1310 and 1311, respectively.

A technical advantage of the structural generation process is depicted in FIG. 13. In some embodiments, the number of children for structural elements may vary (based on the type of Structure Generator used), as shown with the Section 1302 with only one child Phrase 1304, the Phrase 1304 with three Sub-Phrase children 1306-1308, and Sub-Phrase 1306 with two Music Unit children 1310-1311. In addition, another technical advantage that may be realized with the structural generation process in combination with Musical Themes is that the Musical Theme 1328 may have repetition and variation within its structure. In some embodiments, FIG. 13 depicts the Sub-Phrase 1308, which may be a variation of the Sub-Phrase 1306. This generation rule may extend to at least one sub-element in the structure.

In the embodiment depicted in FIG. 13, for example, both of the Sub-Phrase 1308's children, Music Units 1313-1314 are also variations of Music Units 1310-1311, respectively, such that the Sub-Phrase 1308 is a variation of the Sub-Phrase 1306. In these and other embodiments, the Sub-Phrase 1307 may be used to generate the Music Unit 1312, which may be different from the Music Units 1310-1311 and the respective variations 1313-1314 of those Music Units 1310-1311.

In some embodiments and as discussed herein, the real-time structure may generate music one Music Unit 1310-1314 at a time, which may generate symbolic data from the abstract musical material referenced in each Music Unit 1310-1314 of the Musical Theme 1328, or may simply pull the Generated Parts, if those already exist on the Musical Theme's Music Units. When the real-time structure has reached the end of the referenced Musical Theme, as it has at a current-time point 1330, it may then optionally repeat or vary the Musical Theme 1328, or optionally generate a new structure entirely.

In some embodiments in which the Musical Theme 1328 is chosen to be repeated after already being used once, the RT structure may copy the structure of the Musical Theme 1328, and then reference Music Units 1310-1314 of the first instance of the Musical Theme 1328 in the real-time structure. In an example of the RT structure of FIG. 13, this reference to Music Units 1310-1314 of the first instance of the Musical Theme 1328 is shown with the large arching arrow from the repeated Music Unit 1332 to the Music Unit 1310. In some embodiments, when the structure of a Musical Theme 1328 is copied, the Music Units 1310-1314 may not include the musical information stored in a Music Unit, such as the Bases, Abstract Roles or Generated Parts. Rather, it may be configured to include a limited copy the structural elements which may include, without limitation, Sections 1326, Phrases 1324, Sub-Phrases 1320-1322 and Music Units 1315-1319 and create references to those copied elements. The references may allow the musical material of the repeated Music Unit 1332-1333 to be referenced. In an example of the RT structure of FIG. 13, when the repeated Music Unit 1332 is generated, it may not actually have to use any Generators because the Generated Parts may be already populated for all Parts in the Music Unit 1310, and the reference may allow the Music Unit 1332 to extract that information directly from the Music Unit 1310.

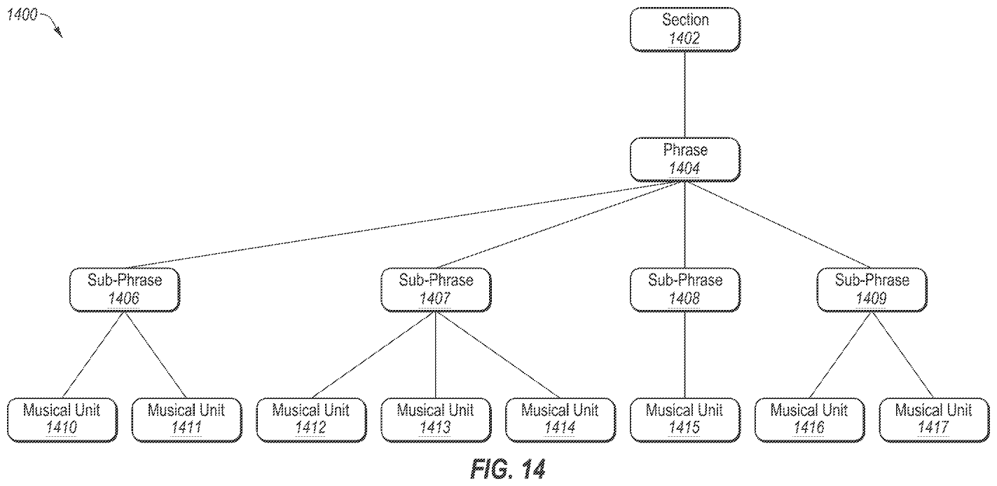

FIG. 14 illustrates an example process 1400 of generating a musical theme using a real-time variation structure according to one or more embodiments of the present disclosure. In some embodiments in which the Musical Theme is chosen to be varied rather than repeated, the RT structure may also be copied, and each structural element may also be referenced to one of the previous iterations of the Musical Theme, but RT structure may also include at least one variation of a previous structural element. In the example depicted in FIG. 14, three Variation Models may be selected to create variations using a Structure Generator, a Rhythm Generator, and a Harmony Generator. For each Generator, a particular Model may then be chosen. In the example depicted, the Structure Generator may be the Insertion Model, the Rhythmic Generator chosen may be the Shift Model, and the Harmony Generator chosen may be the Hidden Markov Model (HMM) Model. The Insertion Model may insert a new structural element, Sub-Phrase 1407; the Rhythmic Model may shift certain onsets in one of the Generated Parts in Sub-Phrase 1408's child, MU 1415; and the HMM Model may modify the Abstract Role of the harmony for one of Sub-Phrase 1406's children, MU 1410.

In some embodiments, a Section of music 1402 may be a variation of a musical theme, a segment of a previously generated music unit, a copied musical structure, some combination thereof, or any other audio that may be played, such as the Section 1302 described in relation to FIG. 13. Making variations to the Section 1402 with respect to a structure, rhythm, harmony, or some combination thereof of the audio may result in generation of a Phrase 1404, which may itself be decomposed into Sub-Phrases 1406-1409. Each of the Sub-Phrases 1406-1409 associated with the Phrase 1404 may represent some variation of the Phrase 1404. For example, adding a harmony variation to a Sub-Phrase via an HMM model may result in the Sub-Phrase 1406, while making a Structure Variation to a Sub-Phrase via an insertion of a new element may result in the Sub-Phrase 1407. Additionally or alternatively, performing a Rhythm Variation may result in a model shift corresponding to Sub-Phrase 1408.

In these and other embodiments, variations and/or repetitions may be made with respect to the Music Units output with respect to the Sub-Phrases 1406-1409. For example, MUs 1410 and 1411 may be output with respect to the Sub-Phrase 1406 in which the MU 1410 includes a modified Abstract Role of the harmony, and the MU 1411 is a repetition of the MU 1311 as described in relation to FIG. 13. The Sub-Phrase 1407 may be decomposed into a MU 1412, a repetition of the MU 1412, which is MU 1413, and a MU 1414. The Sub-Phrase 1408 may output MU 1415 based on shifting of certain rhythmic onsets in one of the Generated Parts, and the Sub-Phrase 1409, which may be a repetition of the Sub-Phrase 1406, may output a repetition of the MU 1410 as MU 1416 and/or a variation of the MU 1411 as MU 1417.

In some embodiments and beyond the use of real-time-generated Parts, the RTAMGS may allow for the triggering and playback of pre-rendered audio files that are mixed into the final output buffer along with other Parts. In an example, the RTAMGS may trigger pre-rendered drum loops, chord progressions and/or melodic lines which may constrain the musical output of the system. The RTAMGS may be configured to generate music Parts super-imposed on the pre-rendered audio files. In an example, the system may playback a pre-rendered drum loop while generating the lead and arpeggio Parts in real-time. The pre-rendered audio files may be accompanied with musical annotations (e.g., score, chord sequence) and metadata (e.g., Emotion, Style), which may be used by the RTAMGS to modify the generation of the super-imposed Parts, in order to generate musical material that is coherent with the pre-rendered audio files. The use of pre-rendered audio files in conjunction with real-time-generated Parts may shrink the set of possible musical outcomes.

In some embodiments, the RTAMGS may further include components and/or systems for the crafting of Musical Themes by users of any musical skill level. Thus, in some embodiments, the RTAMGS may include a Theme Generator component/system, which may be a generative system, configured to generate a Musical Theme. The Theme Generator may be configured to allow a user to specify descriptive elements of the type of music they want, and to generate a Musical Theme to those specifications. In order to hear the Musical Theme, the user may select a musical Style (and an optional Emotion, which may be defaulted to “neutral”), with which the Theme Generator may then subsequently generate and play that generated Musical Theme.

In some embodiments and after a Musical Theme is generated, the Theme Generator may be configured to allow a user to select specific parts of the music to modify. In an example, the Theme Generator may be configured to allow a user to select, modify, remove or add particular notes or other symbolic data in a melody, one or more chords, a rhythmic phrase, or even just a region of the full polyphonic composition. In some embodiments, the Theme Generator may be further configured to regenerate user-selected musical elements. When re-generated, the Theme Generator may be configured to provide the user with multiple options. In an example, the user may select an option from the newly generated musical content and insert it into their Musical Theme. Or, if unsatisfied, a user may repeat this process multiple times. Each time, the Theme Generator may be configured to use AI Models to craft that particular musical element more to the user's liking, based on the previous selections of generated material. It is to be appreciated that the Theme Generator may be configured to learn from each compositional decision the user makes to learn and even later predict the user's musical preferences.

Additionally or alternatively, the Theme Generator may also be configured to allow the user to directly input musical content. In an example, the Theme Generator may be configured to allow the user to specify exact notes that they want to be played for a melody, either through an editing interface or by uploading a digital piece of music. The example is not limited in this context and may apply to all types of musical material which may include, without limitation, harmonic progressions, rhythmic patterns, and/or performative elements (e.g., specifying strums, bends, slides etc.).

The RTAMGS may be configured to provide another user-based creation process known as Instrument Creation Workflow. The Instrument Creation Workflow may allow users to customize the Instruments used to play back the generated music in real-time and save their changes. In some embodiments, users may modify the Instruments in the system by changing their production parameters and/or Effects. The RTAMGS may use machine-learning in order to facilitate the crafting of musical Instruments to a user's preferences. In an example, evolutionary algorithms may be used in an iterative workflow, such that the user may be presented with multiple examples of a new version of the Instrument they are modifying, with different production parameters selected by the machine-learning model for each. In this example, the user may select a subset of the generated sounds, indicating their preference for that subset. Then, the RTAMGS may generate a set of sounds that uses the parameters of the selected subset as the reference set of parameters to spawn a new ‘generation’ (in the evolutionary sense) of sounds. With each iteration, the user may feel that the sounds increasingly reflect their tastes.

In another embodiment, the users may upload their own virtual instruments such as synthesizers and/or sample libraries and or virtual instrument packages such as VSTs, Max/MSP patches or Pure Data patches. These external virtual instruments may then be stored and utilized as Instruments within the RTAMGS.

In an example, when modifying a guitar Instrument, the user may change the degree of distortion and/or chorus to apply. In an example, users may choose and/or modify presets for the Instruments, Effects, and Performance Models/Techniques provided with the RTAMGS in order to reflect a target Emotion the user may want to achieve.

The user may be presented with parameters that represent more semantic information. In another example, an Instrument may have a modifiable parameter that is named “underwater” or “scratchiness”, for which an Instrument may sound perceptually more or less “underwater” or “scratchy” based on these semantic concepts. The RTAMGS may have presets for 0% “underwater” and 100% “underwater” and may interpolate between the two presets.

The RTAMGS may be configured to provide the ability to modify and manipulate generated content after the fact and save/store Musical Themes. In some embodiments, users may re-generate Musical Themes and/or change Instruments and/or change Style and/or Emotion until they are satisfied with the musical outcome.

The RTAMGS may be configured to receive input directly by composer. In some embodiments, composer may input her own Musical Themes in the system, which may then be used as a reference for generation by the RTAMGS. The RTAMGS may be configured to allow creators to craft their own musical scenarios, based on Emotion, Style and Theme. The RTAMGS may configure the Cues to contain: one or more (or a single) Style specifications (since Styles may contain configurations, this can also be a mash-up of one or more Styles); an initial Emotion; and/or one or more Musical Themes. The Musical Themes may be generated, composed, or crafted through generation and editing. Additionally or alternatively, one or more Cues may be active when RTAMGS is generating music, and within a Cue, the music may be self-referential but non-repeating to create infinite music.

The RTAMGS may be configured to generate music in a Cue in real-time with non-repeating audio. In some embodiments, the generated music for a Cue may adapt to the position of the user in a digital experience and/or to her interactions. In a non-limited example, the music generated by the system may display chord progressions that may be more or less complex depending on the position of the user.

The RTAMGS may be configured to generate a musical structure for a Cue that may provide musical coherence. In some embodiments, the coherence of the musical content of a Cue is guaranteed through the use of repeated, varied and new structural elements at all levels of the musical structure.

The RTAMGS may be configured to generate repetitions that occur at a particular structural level, such as that of the ‘Section’. This aspect, along with the fact that the system may generate infinite variations of the referenced musical material, may remove the sense of listener fatigue that is often present in music for interactive content such as video games.

The RTAMGS may be configured to enable the user to control the level of repetition desired when crafting a Cue. This aspect may allow the user to decide the degree to which the Cue should propose new musical material. The level of repetition may be associated with the emotion the user may want to convey. In an example, pieces with high repetition levels may result in higher-valence emotional states. By contrast, pieces featuring little repetition may be associated with low-valence emotions. Therefore, this feature may give the user extra control over the valence dimension of emotion, and users may control the level of repetition within a Cue.

The RTAMGS may be configured to define musical scenarios that transition between two or more Cue states. These may be termed as Transition States, or simply Transitions. A Transition object may be defined by the RTAMGS and made available to the user or connected computer system, such that certain Transitions may be tied to particular user scenarios. These Transition objects may be made available to the user or connected computer system, such that certain Transitions may be tied to particular user scenarios. The user may choose from a set of Transition types or define their own custom parameters for the Transition they are creating.

A Transition may be defined by the RTAMGS to contain all of the necessary information for transitioning the musical scenarios between Cues. In an example, this information may include duration, method (which may include discrete and interpolated), and emotional trajectory. In some embodiments and during the Transition state, the real-time structure used to generate music is either the real-time structure of the starting Cue, or a custom real-time structure that borrows from both Cues. At the end of any Transition, the destination Cue will be activated in the same way that Cues are normally activated.

In some embodiments, a Transition may be defined simply as a ‘fade-out’ type between two Cues. In this embodiment, the real-time structure of the previous Cue will be used, and the Production system may simply reduce the volume of the output audio signal, interpolating from the previous volume to 0. At the end of the Transition, the destination Cue may be activated, such that the real-time structure is instantiated with all relevant musical information necessary to generate music in that Cue state.

In another embodiment, a Transition may be created which lasts for two measures, and transitions between a Hero Cue and a Boss Cue. In the Hero Cue, the Emotion may be ‘tender’, the Style may be ‘Medieval’, and there may be a Musical Theme defined for that hero (the “Hero's Theme”). Similarly, the Boss Cue may be defined as having the Emotion ‘angry’, the Style ‘Electronic Dance Music’, and the Musical Theme “Boss Theme”. In a continuation of the embodiment, the Transition may be defined to have a “U-shaped” emotional trajectory, which may drop the arousal down below the level defined by the ‘tender’ Emotion before moving it up to the level defined by ‘angry’. This emotional trajectory may be applied over the duration as defined in the Transition object. Similarly, the Transition object may have a discrete method defined, such that the music may transition between Cues in a stepwise fashion, creating the sense of progress between Cues.

In some embodiments, the discrete transition may, as a first step, change the Rhythmic Generators to move towards the destination scenario, as a second step additionally change the Part Models for all Parts with a melody or harmony Role, as a third step additionally change the Instruments for all Parts and begin to borrow compositional material from the Musical Theme of the final musical scenario, in a final step change all the remaining configuration settings for Style and Musical Theme. During this example embodiment, an emotional trajectory may be applied which may add an additional change to any or all configuration settings. In this embodiment, the Transition must create a custom real-time structure that borrows musical and structural elements from both Cues.

In some embodiments, musical parameters may be defined on a continuous scale, so that parameters may be connected directly to continuous input variables. The input variables may be mapped onto musical parameters using several functions, such as but not limited to, linear, exponential and polynomial functions. In some embodiments, musical parameters may be dependent on in-experience parameters (e.g., player position, health level), Emotional parameters and/or Style. In an example, the distance of the player from a point in a video game scene may be mapped onto the note density musical parameter (responsible for the number of note onsets in a passage) with a linear function. In another example related to Affective Mapping Models, the valence parameter of an Emotion may be mapped onto the harmonic complexity parameter (which may be responsible for the amount of dissonance in a musical passage) with an inverse exponential function. In this example, the lower the valence the higher the harmonic complexity. In some embodiments, the music parameters may change when transitioning from one Style to another, in order to create a smooth stylistic transition in the music generated.

The mapping of continuous variables onto musical parameters may be thresholded, in order to create discrete values for the musical parameters. This approach may be used to enable discrete-based AI techniques such as but not limited to Hidden Markov Models to be employed in the RTAMGS. In an example, the harmonic complexity parameter used as an observation variable in the Hidden Markov Model responsible for generating abstract harmonies may assume only four values depending on the valence parameter.

In some embodiments, the RTAMGS may be extended with a cloud platform which may feature a user profiling service, user accounts, user's assets storage and a marketplace. The cloud platform may improve the experience of the users with the system, by enabling music content generation that is specifically targeted to the preferences of a user, and/or access to musical assets that may quicken and improve the music generation process. In some embodiments, the behavior and compositional choices of the user when using the RTAMGS may be stored in the cloud platform. This data may contribute to build a user profile, that may inform the AI modules to generate music that may be tailored to the user. In some embodiments, users may create an account on the cloud platform which may grant them access to the RTAMGS and to store the musical assets they may have bought on the marketplace. The musical assets stored in the cloud platform may be downloaded when the user uses the RTAMGS in a host application. Storage and user accounts on the cloud platforms may allow the user to have access to her musical assets across multiple host applications. In an example, the marketplace may allow users to buy or sell musical assets such as Musical Themes, Cues, Style definitions, Instrument packages, and Effects.

In some embodiments, Musical Themes and Cues composed by users may be bought on the marketplace, which may improve the quality of the music generated by the RTAMGS. In some embodiments, Musical Themes bought on the marketplace may be used as input in the system to provide human-composed reference musical material that may be developed and adapted by the RTAMGS into different Styles and Emotions. In some embodiments, Cues bought on the marketplace may be used by users as input into the system to provide an almost plug-and-play solution to include adaptive music associated to a specific scenario. In this embodiment, the user may not need to specify all of the parameters to be set during the Cue creation process, as these may be already given in the purchased Cue. In another embodiment, Musical Themes bought on the marketplace may be interpreted as a way of obtaining high-quality reference musical material, that may still need user input to configure Cues to create highly customized music. By contrast, Cues purchased on the marketplace may streamline the music creation process, by providing a quick and effective means of devising music for a scenario, at the cost of possibly lowering customization.

In some embodiments, Style definitions may provide new musical Styles the user may use to add variety to the music. In some embodiments, Style definitions may include the set of presets for all of the configuration values for the parameters of the composition, performance, and/or production components. In an example, there may be a “baroque” Style definition that contains information about the configuration settings necessary to generate, perform and produce baroque music.

In some embodiments, Instrument packages sold on the marketplace may be synth-based and/or sample-based Instruments and/or a series of preset parameters that may be different embodiments of the same Instrument. Users may purchase Instrument packages to enrich the timbral palette of the RTAMGS. In an example, a user may purchase a “rock guitar” Instrument with a series of presets such as but not limited to “distorted guitar”, “chorus guitar”, and/or “phaser guitar”.

In some embodiments, packages sold on the marketplace may be a combination of Styles, Cues, or Instruments that may represent a particular artist's style, song, instrument or sound. The user could use these Artist Packs or Artist Packages in conjunction with the RTAMGS to generate an infinite stream of music in that musical artist's style.

In some embodiments, the RTAMGS may be configured to learn from the music compositional decisions the user has made and/or his musical preferences stored in the cloud platform. In some embodiments, the system learns from the Instruments, the Musical Themes, the Styles and/or the user has chosen over time. The system may use this data to inform the parameters of the AI modules used to generate and/or perform and/or produce music, in order to playback to the user music that is stylistically and/or emotionally close to her preferences and past compositional choices. In an example, if a user tends to prefer Musical Themes with a similar note density; the system will change the values of the parameters of its melody Role Generator, in order to serve to the user Musical Themes that may have a similar note density to the purchased or preferred Musical Themes.

In some embodiments, the RTAMGS may learn from a user's input decisions in an online (or real-time) fashion, so that the machine learning models learn from the user in a single session in a supervised learning scenario. In one such embodiment, evolutionary algorithms may be used in the generation of a melody such that the following supervised learning process can occur:
1. The user can be presented with multiple generated melodies (in evolutionary algorithms, a ‘generation’).
2. The user can select a subset of that original set of melodies that represents their personal preference.
3. A new generation of melodies is created based on the parameters that were used to generate the subset of melodies that were selected by the user (by merging, averaging, and adding noise to the parameter sets), and this new generation of melodies can again be presented to the user.
4. Steps 2 and 3 can be iterated on until the user has found the one melody that they prefer the most, which will then be used in the Musical Theme.

This process can be done not only with Parts and Models for the Composition Component/System, but also for the Performance Component/System and the Production Component/System, or those models that provide functionality across multiple Components/Systems. Emotional Component/System.

In some embodiments, the RTAMGS may define an Emotion, which may contain a two-or-more dimensional vector in an emotional space, as defined herein, as well as some auxiliary information.

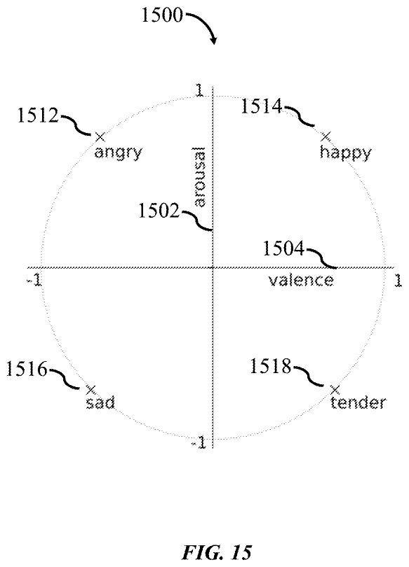

In some embodiments, the RTAMGS may further include an emotional component/system generally configured to determine and/or map one or more emotional trajectories. FIG. 15 illustrates example emotion points 1512, 1514, 1516, and 1518 in a valence-arousal space 1500 according to one or more embodiments of the present disclosure. In some embodiments, the RTAMGS may be configured to receive parameters into the system as emotion, which may be expressed in high-level terms (e.g. “happy”, “sad”, etc.). In some embodiments, the RTAMGS may be configured to map these terms to a 2D point in valence-arousal (VA) space 1500 through the definition of different Emotions.

As illustrated in FIG. 15 and in some embodiments, valence 1504 may represent the difference between positive/negative Emotions such as happy (positive) 1514 and angry (negative) 1512, and arousal 1502 may represent the difference between active/passive Emotions such as happy (active) 1514 and tender (passive) 1518.

Additionally or alternatively, the RTAMGS may also be configured to map emotional terms to a 3D space that may include valence 1504, arousal 1502, and dominance. Dominance may represent the difference between dominant/submissive emotions such as anger (dominant) and fear (submissive).

In some embodiments, the emotional component/system may be configured to link this 2D or 3D point to a series of musical parameters, which may be referred to as affective mapping. In one embodiment, the one or more musical parameters of the affective mapping may include, without limitation: tempo: (arousal) slow/fast, mode: (valence) minor/major, harmonic complexity: (valence) complex/simple, loudness: (arousal) soft/loud, articulation: (arousal) legato/staccato, pitch height: (arousal) low/high, attack: (arousal) slow/fast, and/or timbre: (arousal) dull/bright.

In particular, the emotional component/system may be configured to sample around this 2D or 3D point for each musical parameter above. This may create extra variety in the music. In some embodiments and when there is an Emotion change, the emotional component/system may be configured to translate (move) the central 2D or 3D point in the emotion space, along with all the associated musical parameters, to a new 2D or 3D point.

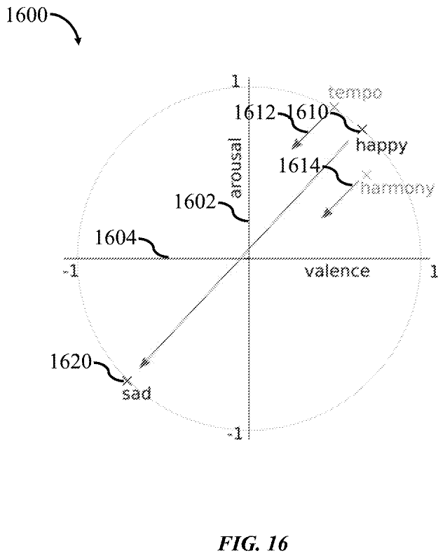

FIG. 16 illustrates an example emotion change of emotion points in a valence-arousal space 1600 according to one or more embodiments of the present disclosure. As illustrated in FIG. 16, an emotion change from happy 1610 to sad 1620 may be affected. Additionally or alternatively, an emotion change 1612 may be affected for tempo, and an emotion change 1614 may be affected for harmony corresponding to the emotion change from happy 1610 to sad 1620.

It is to be appreciated that the emotion changes described in relation to FIG. 16 may in turn cause changes in the music generated by the RTAMGS in real-time. In an example, the tempo may be reduced as the point associated with tempo descends down the arousal axis.

In some embodiments, the emotion space may be constrained from −1 to 1. Additionally, the exact parameter values that are mapped from these may be defined by the Style. In an example, in an “Ambient” Style, the tempo range may be lower (30-80 bpm) whereas in an “EDM” Style the tempo may be substantially higher (100-140 bpm). Furthermore, the linear emotional range may be mapped to nonlinear scales for one or more parameters such as, in some embodiments, volume, cutoff frequency, etc. In an example, the cutoff frequency for a low-pass filter may be mapped in an exponential scale, as humans perceive frequency changes exponentially.

Disclosed herein are example use cases with respect to the emotional component/system, which may be performed in conjunction with one or more applications (e.g., a game engine) executing on the host system. It is to be appreciated that the example use cases are not limited in their respective contexts.

### Example 1

Exploring emotional spaces: A user has set up a virtual space where they have several rooms. This space could be their virtual home, for instance, and the rooms could represent a living room, workout area, and a bedroom. Different activities take place in each of these rooms and need different emotionally driven music to match those activities. To support this, emotional points may be placed within each room, so the living room could have a “happy” Emotion for entertaining, a “tender” Emotion for relaxing in the bedroom, and the gym can be the “angry” emotion for energizing. As the user explores the space, traveling into the different rooms, their virtual position may be mapped onto an emotional position or Emotion, thus creating an emotional trajectory.

### Example 2

A hero and a boss character are both on-screen in a particular video game. The boss has been assigned the “scary” Emotion, while a victory has been assigned the “triumphant” Emotion. As the boss character is vanquished, the music of that scene may need to smoothly transition from “scary” to “triumphant”. The path by which that transition occurs may be a traversal through a 3-dimensional emotional space. There may also be multiple options for eliciting a “triumphant” emotion in the end-user, when starting from a “scary” emotional space, which all are represented as different paths in the space. For example, the user may create an n-shaped traversal that first increases the arousal of the scary music, bringing it to a more “frightening” Emotion, and then ramp down the arousal slightly while simultaneously increasing valence to arrive at the “triumphant” Emotion. In other scenarios, the transition may be a direct interpolation in the emotional space from one Emotion to another. The speed of the transition may also affect the emotional elicitation.

### Example 3

An online forum with many inputs from multiple users (named “agents”). This could be, for example, an online streaming platform that allows its users to give text-based input. That input can be evaluated for its emotional content, giving a large amount of explicit emotional content that needs to be aggregated. The emotional component/system may be configured to determine the aggregate emotion based at least partially on the clustering of those many emotional inputs. Furthermore, given that resulting aggregate Emotion, the emotional component/system may be configured to suggest a change in emotion that may move the crowd's aggregate Emotion towards a desired target Emotion. For example, if the aggregate Emotion is “angry”, and the desired target Emotion is “tender”, it might make sense to first decrease the arousal to a lower point than “tender”, and bring the elicited Emotion to “serene”, before traversing a path through the emotion space to the “tender” Emotion. In this particular scenario, the emotional component/system would allow the users to have a complete emotional break before arriving at a calm but stable emotional state. In the end, this may allow the streaming broadcaster to elicit the desired emotion from a group, given their emotional input, whether explicit (by having the users tag their own emotions) or implicit (by evaluating their current emotional state through emotional estimation of text, for example). It is to be appreciated that the emotional component/system may not include the estimation of emotional content; rather, the emotional component/system may predict an aggregate emotion once that emotional content/input is determined.

### Example 4

Narrative of a story. Feedback for the emotional situation that a current story narrative is in. For example, an author could be writing a particular chapter in which she has two high-level emotional elicitations, “fear” and “hope”. She wants more input into the emotional scenario that she is actually writing for and uses the emotional component/system to find the emotional aggregate of the two. She inputs the two emotions into the emotional component/system and discovers that the aggregate Emotion is “anxious”. This particular example is high-level, and the emotional component/system may be configured to provide a 2D or 3D point vector in the emotion space.

### Example 5

Shared listening experiences in interactive media. A user (User 1) in a game environment may be listening to a particular music stream generated by the RTAMGS, with a Cue that the user has created. Another game user (User 2) may desire to listen to the same musical stream, and therefore the RTAMGS may split the musical stream so that the music is fully synchronized across both users. The music may then be modified directly by user input—User 2 may change the Style of the Cue, or select another Cue for the pair of users to listen to, such as a Cue that User 1 has not purchased. As the pair move through the game environment, the music continues to adapt to the environment based on their shared experience/gameplay, such that the music is always synchronized. In another example, this could be a pool party scenario in a Virtual Reality environment, and there could be any amount of users sharing the music stream (such as 40 users at the same virtual pool party). If all of the users start jumping, the music could change such that the Arousal increases or such that the tempo matches the rate at which the group is jumping. Control of the musical changes can be limited based on permissions and ownership. Additionally or alternatively, the emotional component/system may be configured to adapt to changes in one or more applications (e.g., game engine, etc.), provide a unique experience for each user (or groups of users, if desired) or each runtime, and change users' emotion through emotional trajectories.

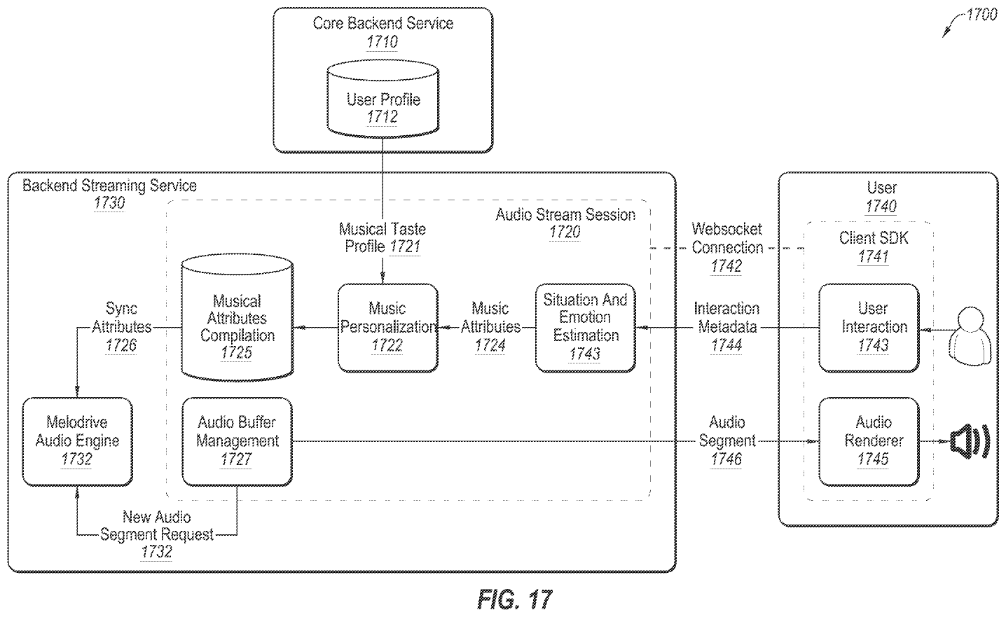

FIG. 17 illustrates an example cloud streaming service 1700 configured to perform a music generation process according to one or more embodiments of the present disclosure. The cloud streaming service 1700 may facilitate access to infinite streams of music and continuous, real-time control of the music generation process such that a user may dynamically adjust generated music and receive immediate feedback on the adjustments.

The cloud streaming service 1700 may include a computer architecture that relies on a centralized streaming service and houses a Melodrive audio generation engine. Websocket connections 1742 can be established with this cloud streaming service 1700 from clients such as games or web-based applications through a custom client SDK 1741 that facilitates bi-directional communication. The client SDK 1741 renders chucks of audio received from a backend streaming service 1730 into a format that the client application can play as audio via an audio renderer 1745. It also provides an API that can be used to stream user interaction events and game metadata (collectively referred to herein as “user interaction 1743”) to the streaming service as interaction metadata 1744, that are then translated into musical attributes 1724 using machine learning tools and user preferences. The client-side SDK 1741 that establishes the Websocket connection 1742 with the backend streaming service 1730 may be used to facilitate the real-time rendering of audio, such as via the audio renderer 1745, from the backend streaming service 1730 based on the client's runtime environment. The connection 1742 may also be used to pass user interaction events 1743 as well as game metadata to the backend streaming service 1730.

In some embodiments, the backend streaming service 1730 may generate an audio stream session 1720 corresponding to new or updated input from user 1740. The user interaction 1743 being sent as interaction metadata 1744 may be received by a situation and emotion estimation module 1723 of the backend streaming service 1730. The situation and emotion estimation module 1723 may be configured to ingest the interaction metadata 1744 from the client SDK 1741 and interpret the situation and emotional context of the data so that it can be mapped to the musical attributes 1724. A music personalization module 1722 may be configured to generate a musical attribute compilation 1725 based on information stored within a user profile 1712 (favorite instruments, styles, etc. represented as a musical taste profile 1721 in FIG. 17) stored on a core backend service 1710 and the musical attributes 1724 so that the situation and emotion information can be translated into musical attributes that are meaningful to the user 1740.

When the audio stream session 1720 is established between the client SDK 1741 and the backend streaming service 1720, a store of session variables, represented by the musical attributes compilation 1725, may be established. The musical attributes compilation 1725 may include the musical attributes 1724 that are synced with a Melodrive audio engine 1732 to generate audio (represented as sync attributes 1726 in FIG. 17). In some embodiments, the Melodrive audio engine 1732 may be the music generation engine of the backend streaming service 1730. The Melodrive audio engine 1732 may handle the generation of symbolic musical representations using AI that are then translated into raw audio. As clients interact with the backend streaming service 1730, these attributes will update and change the music that is streamed to the clients in real-time. Unlike audio streaming services that stream a fixed piece of audio to one or more clients, the Melodrive audio engine 1732 generates a music stream that is dynamic and generated in real-time. Due to this, a loop is established between the Melodrive audio engine 1732 and an Audio Buffer Management module 1727. This class constantly sends new audio segment requests 1728 to the client once the current buffer has been consumed. It also includes a backpressure mechanism to ensure the Melodrive audio engine 1732 is kept in sync with the audio playback on the client side.

Elements of the cloud streaming service 1700, including, for example, the situation and emotion estimation module 1723, the music personalization module 1722, the audio buffer management module 1727, and/or the Melodrive audio engine 1732 (generally referred to as “computing modules”), may include code and routines configured to enable a computing system to perform one or more operations. Additionally or alternatively, the computing modules may be implemented using hardware including a processor, a microprocessor (e.g., to perform or control performance of one or more operations), a field-programmable gate array (FPGA), or an application-specific integrated circuit (ASIC). In some other instances, the computing modules may be implemented using a combination of hardware and software. In the present disclosure, operations described as being performed by the computing modules may include operations that the computing modules may direct one or more corresponding systems to perform. The computing modules may be configured to perform a series of operations with respect to the interaction metadata 1744, the musical attributes 1724, the musical taste profile 1721, the sync attributes 1726, the new audio segment requests 1728, and/or the audio segment 1746 as described above.

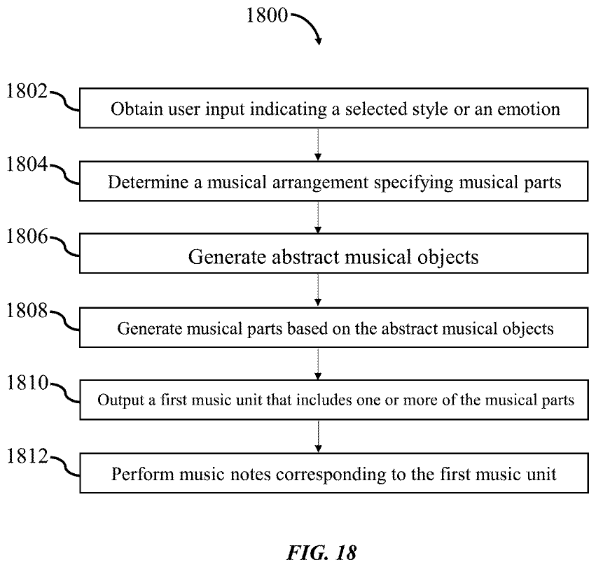

FIG. 18 is a flowchart of an example method 1800 of music generation according to one or more embodiments of the present disclosure. The method 1800 may be performed by any suitable system, apparatus, or device. For example, the RTAMGS 100 of FIG. 1 may perform one or more operations associated with the method 1800. Although illustrated with discrete blocks, the steps and operations associated with one or more of the blocks of the method 1800 may be divided into additional blocks, combined into fewer blocks, or eliminated, depending on the particular implementation.

The method 1800 may begin at block 1802, where user input indicating a selected style or an emotion may be obtained. In some embodiments, the user input may be obtained from multiple different users and represent an aggregated result based on the respective inputs provided by each of the different users. Additionally or alternatively, the user input may or may not be provided directly by the user and may be programmatically generated based on a trigger event, such as a video game scene mapping or user interaction with some software. Additionally or alternatively, the user input may be programmatically generated based on a music taste profile associated with one or more users in which the music taste profile is estimated according to previous user input provided by the one or more users associated with the music taste profile.

In some embodiments, the user input may involve a selection of a section of a previously outputted music unit that includes one or more musical notes and an updated style or an updated emotion. The user input may involve a modification to be made to the selected section of the previously outputted music unit that involves changing one or more abstract musical objects or one or more musical parts associated with the selected section of the previously outputted music unit.

At block 1804, a musical arrangement specifying musical parts may be determined. The specified musical parts of the musical arrangement, when played together, may correspond to a musical composition that satisfies the style or the emotion indicated by the obtained user input.

At block 1806, abstract musical objects may be generated. Each of the abstract musical objects may indicate properties of the musical composition or specify a relationship between two or more other abstract musical objects in which the properties of the musical composition may include, for example, data representations of musical notes, rhythms, chords, scale degree intervals, or some combination thereof. Additionally or alternatively, context objects may be generated based on a subset of the abstract musical objects in which a particular context object represents one or more of the most recently generated abstract musical objects. By basing the generation of musical parts on the context objects, updated musical parts may better correspond to the most recent developments in the real-time music generation process.

At block 1808, musical parts may be generated based on the abstract musical objects. In some embodiments, a particular musical part may be a virtual representation of a respective musical instrument (e.g., a trumpet, a flute, a piano, etc.) and/or a sound generator (e.g., blowing wind, animal calls, machinery sounds, etc.). In these and other embodiments, audio effects, such as reverberations, may be applied to one or more of the generated musical parts, and the outputting of the first music unit may involve applying the audio effect to the music composition with respect to the corresponding musical parts.

In some embodiments, the musical parts may be updated based on new user input, such as an updated style or an updated emotion. Updating the musical parts may affect the outputting of the music units by updating existing music units generated based on the musical parts and/or generating a new music unit based, in part or exclusively, on the updated musical parts.

At block 1810, a first music unit that includes one or more of the musical parts may be output. In some embodiments, a particular music unit may represent musical notes, that when played, result in performance of a corresponding musical composition. In some embodiments, the first music unit or any other music units may be outputted as symbolic data in which inputting the symbolic data returns a corresponding sequence of music notes representative of a particular musical composition. The symbolic data may be recorded or copied (e.g., as a seed value) so that the first music unit may be reproduced by inputting the symbolic data on any computer device configured to perform the method 1800.

At block 1812, music notes corresponding to the first music unit may be performed. In some embodiments, one or more additional music units may be generated after the first music unit has begun to be played and at least one beat before the music notes associated with the first music unit are finished playing. Music notes associated with another music unit (e.g., a second music unit) generated during this time frame may be played after the music notes associated with the first music unit are finished being played to form a seamless connection between playing the music notes of the first music unit and the music notes of the second music unit.

Modifications, additions, or omissions may be made to the method 1800 without departing from the scope of the disclosure. For example, the designations of different elements in the manner described is meant to help explain concepts described herein and is not limiting. Further, the method 1800 may include any number of other elements or may be implemented within other systems or contexts than those described.

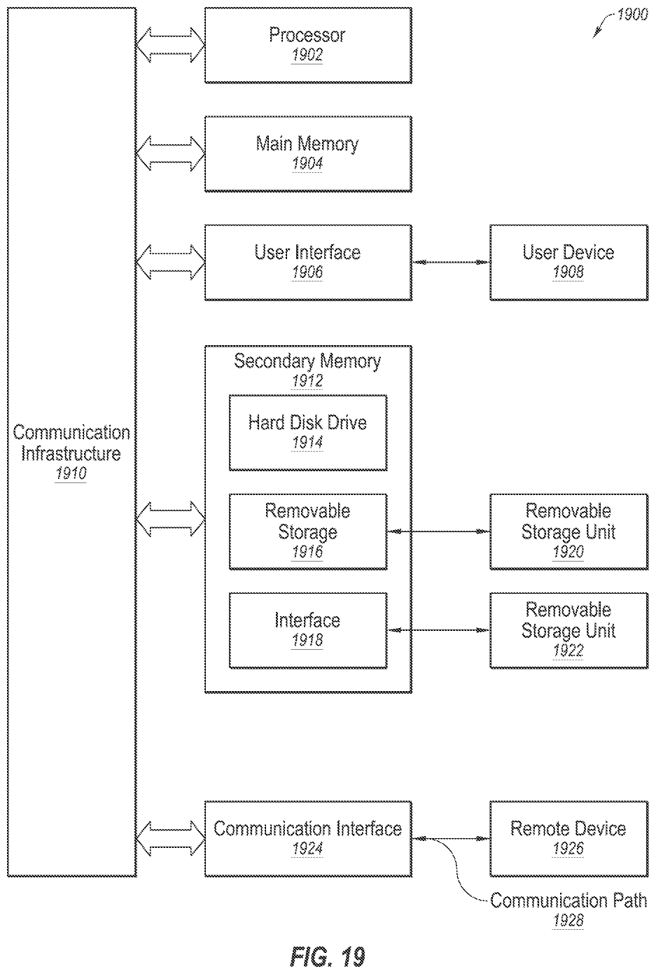

FIG. 19 is an example computing system 1900 according to one or more embodiments of the present disclosure. Various embodiments and components therein can be implemented, for example, using one or more well-known computer systems, such as, for example, the example embodiments, systems, and/or devices (e.g., host system, embedded system, mobile devices etc.) shown and discussed above with respect to the figures or otherwise discussed. Computer system 1900 can be any well-known computer capable of performing the functions as illustrated in the figure below and further described herein.

As illustrated above, the computer system 1900 includes one or more processors (also called central processing units, or CPUs), such as a processor 1902. Processor 1902 is connected to a communication infrastructure or bus 1910.

One or more processors 1902 may each be a graphics processing unit (GPU). In some embodiments, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1900 also includes user input/output device(s) 1908, such as monitors, keyboards, pointing devices, sounds cards, digital to analog converters and analogic to digital converters, digital signal processors configured to provide audio input/output, etc., that communicate with communication infrastructure 1910 through user input/output interface(s) 1906.

Computer system 1900 also includes a main or primary memory 1904, such as random-access memory (RAM). Main memory 1904 may include one or more levels of cache. Main memory 1904 has stored therein control logic (i.e., computer software) and/or data.

Computer system 1900 may also include one or more secondary storage devices or memory 1912. Secondary memory 1912 may include, for example, a hard disk drive 1914 and/or a removable storage device or drive 1916. Removable storage drive 1916 may be a floppy disk drive, a magnetic tape drive, a compact disk drive, an optical storage device, tape backup device, and/or any other storage device/drive.

Removable storage drive 1916 may interact with a removable storage unit 1920, 1922. Removable storage unit 1920 includes a computer usable or readable storage device having stored thereon computer software (control logic) and/or data. Removable storage unit 1920, 1922 may be a floppy disk, magnetic tape, compact disk, DVD, optical storage disk, and/any other computer data storage device. Removable storage drive 1916 reads from and/or writes to removable storage unit 1920, 1922 in a well-known manner.

According to an exemplary embodiment, secondary memory 1912 may include other means, instrumentalities or other approaches for allowing computer programs and/or other instructions and/or data to be accessed by computer system 1900. Such means, instrumentalities or other approaches may include, for example, a removable storage unit 1916 and an interface 1918. Examples of the removable storage unit 1916 and the interface 1918 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1900 may further include a communication or network interface 1924. Communication interface 1924 enables computer system 1900 to communicate and interact with any combination of remote devices, remote networks, remote entities, etc. (individually and collectively referenced by reference number 1926). For example, communication interface 1924 may allow computer system 1900 to communicate with remote devices 1926 over communications path 1928, which may be wired and/or wireless, and which may include any combination of LANs, WANs, the Internet, etc. Control logic and/or data may be transmitted to and from computer system 1900 via communications path 1928.

In some embodiments, a non-transitory, tangible apparatus or article of manufacture comprising a non-transitory, tangible computer useable or readable medium having control logic (software) stored thereon is also referred to herein as a computer program product or program storage device. This includes, but is not limited to, computer system 1900, main memory 1904, secondary memory 1912, and removable storage units 1920 and 1922, as well as tangible articles of manufacture embodying any combination of the foregoing. Such control logic, when executed by one or more data processing devices (such as computer system 1900), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 19. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections can set forth one or more but not all exemplary embodiments as contemplated by the inventor, and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “some embodiments,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with some embodiments, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents.

What is claimed is:

1. A method, comprising:
obtaining user input indicating a musical style or an emotion corresponding to musical performance;
determining a musical arrangement that specifies one or more musical parts that, when played together, correspond to a musical composition that satisfies the style or the emotion indicated by the obtained user input;
generating a plurality of abstract musical objects, each abstract musical object of the plurality indicating properties of a musical composition or specifying a relationship between two or more other abstract musical objects of the plurality, wherein the properties of the musical composition include data representations of musical notes, rhythms, chords, or scale degree intervals associated with the musical composition;
generating the one or more musical parts based on the plurality of abstract musical objects and the musical arrangement in which a particular musical part depends on one or more of the abstract musical objects of the plurality; and
outputting a first music unit that includes one or more of the generated musical parts, the first music unit corresponding to a virtual representation of the musical composition.

2. The method of claim 1, further comprising:
generating a second music unit after the first plurality of music notes have begun to be played and at least one beat before the first plurality of music notes is finished playing, the second music unit being generated based on one or more of the abstract musical objects, the musical arrangement, and the first music unit;
outputting the second music unit corresponding to a virtual representation of the musical composition.

3. The method of claim 1, wherein outputting the first music unit includes:
composing a first plurality of music notes representative of the musical composition;
modifying the first plurality of music notes based on the musical style or the emotion indicated by the obtained user input; and
specifying a configuration and settings of virtual instruments, virtual sound generators, or audio effects to output the modified first plurality of music notes as audio.

4. The method of claim 1, wherein audio effects corresponding to a respective musical style are applied to a particular musical part of the one or more musical parts in which the particular musical part represents a respective musical instrument or a sound generator.

5. The method of claim 4, wherein outputting the first music unit includes applying the audio effects to the music composition that includes a combination of one or more of the generated musical parts.

6. The method of claim 1, further comprising:
generating a context object based on a subset of the generated plurality of abstract musical objects that represents one or more most recently generated abstract musical objects of the plurality; and
generating one or more updated musical parts based on the context object, the musical style, and the emotion.

7. The method of claim 1, further comprising:
obtaining a user selection specifying a section of the outputted first music unit that includes one or more musical notes of the plurality and an updated style or an updated emotion;
obtaining a user revision input indicating a modification to be made to the section of the outputted first music unit, the user revision input specifying a change to one or more of the abstract musical objects of the plurality or one or more of the musical parts;
generating one or more updated musical parts based on the updated style or the updated emotion, the one or more updated musical parts corresponding to the musical parts associated with the specified section of the outputted first musical unit;
outputting a third music unit based on the one or more updated musical parts, the third music unit corresponding to a virtual representation of the musical composition based on the one or more updated musical parts in which the third music unit sequentially follows the first music unit or replaces the first music unit.

8. The method of claim 1, wherein the user input is obtained from multiple different users, the user input representing an aggregated result based on respective inputs from the multiple different users.

9. The method of claim 1, wherein the user input is programmatically generated based on a video game scene mapping.

10. The method of claim 1, wherein the user input is based on a user music taste profile that is estimated according to previous user input provided by a user associated with the user music taste profile or customized by user selection.

11. The method of claim 1, wherein the first music unit is outputted as symbolic data in which inputting the symbolic data, by another user, returns the virtual representation of the musical composition corresponding to the first music unit.

12. A system, comprising:
one or more processors; and
one or more non-transitory computer-readable storage media configured to store instructions that, in response to being executed, cause the system to perform operations, the operations comprising:
obtaining user input indicating a musical style or an emotion corresponding to musical performance;
determining a musical arrangement that specifies one or more musical parts that, when played together, correspond to a musical composition that satisfies the style or the emotion indicated by the obtained user input;
generating a plurality of abstract musical objects, each abstract musical object of the plurality indicating properties of a musical composition or specifying a relationship between two or more other abstract musical objects of the plurality, wherein the properties of the musical composition include data representations of musical notes, rhythms, chords, or scale degree intervals associated with the musical composition;
generating the one or more musical parts based on the plurality of abstract musical objects and the musical arrangement in which a particular musical part depends on one or more of the abstract musical objects of the plurality; and
outputting a first music unit that includes one or more of the generated musical parts, the first music unit corresponding to a virtual representation of the musical composition.

13. The system of claim 12, further comprising:
generating a second music unit after the first plurality of music notes have begun to be played and at least one beat before the first plurality of music notes is finished playing, the second music unit being generated based on one or more of the abstract musical objects, the musical arrangement, and the first music unit;
outputting the second music unit corresponding to a virtual representation of the musical composition.

14. The system of claim 12, wherein outputting the first music unit includes:
composing a first plurality of music notes representative of the musical composition;
modifying the first plurality of music notes based on the musical style or the emotion indicated by the obtained user input; and
specifying a configuration and settings of virtual instruments, virtual sound generators, or audio effects to output the modified first plurality of music notes as audio.

15. The system of claim 12, wherein audio effects corresponding to a respective musical style are applied to the particular musical part.

16. The system of claim 12, further comprising:
generating a context object based on a subset of the generated plurality of abstract musical objects that represents one or more most recently generated abstract musical objects of the plurality; and
generating one or more updated musical parts based on the context object, the musical style, and the emotion.

17. The system of claim 12, further comprising:
obtaining a user selection specifying a section of the outputted first music unit that includes one or more musical notes of the plurality and an updated style or an updated emotion;
obtaining a user revision input indicating a modification to be made to the section of the outputted first music unit, the user revision input specifying a change to one or more of the abstract musical objects of the plurality or one or more of the musical parts;
generating one or more updated musical parts based on the updated style or the updated emotion, the one or more updated musical parts corresponding to the musical parts associated with the specified section of the outputted first musical unit;
outputting a third music unit based on the one or more updated musical parts, the third music unit corresponding to a third plurality of music notes modified according to the user revision input; and
performing the third plurality of music notes corresponding to the third music unit in place of notes corresponding to the first plurality of music notes in the specified section.

18. The system of claim 12, wherein the user input is obtained from multiple different users, the user input representing an aggregated result based on respective inputs from the multiple different users.

19. The system of claim 12, wherein the user input is based on a user music taste profile that is estimated according to previous user input provided by a user associated with the user music taste profile or customized by user selection.

20. The system of claim 12, wherein the first music unit is outputted as symbolic data in which inputting the symbolic data returns the plurality of music notes representative of the musical composition corresponding to the first music unit.
